(19) United States
(12) Patent Application Publication
(10) Pub. No.: US 2024/0378576 A1
(43) Pub. Date: Nov. 14, 2024

(54) SYSTEM AND METHOD FOR A PAYMENTS SYSTEM

(71) Applicant: REWIRE HOLDING LTD., London (GB)

(72) Inventors: Jose Luis Merino GONZALEZ, London (GB); Jesus Ruiz GONZALEZ, London (GB)

(21) Appl. No.: 18/690,111

(22) PCT Filed: Sep. 8, 2022
(86) PCT No.: PCT/GB2022/052283

§ 371 Date: Mar. 7, 2024

(30) Foreign Application Priority Data
Sep. 8, 2021 (GB) 2112811.1

(51) Int. Cl. G06Q 20/10; G06Q 20/32; G07F 19/00

(52) U.S. Cl. CPC G06Q 20/1085; G06Q 20/3223; G07F 19/203; G07F 19/2055; G07F 19/206; G07F 19/209

(57) ABSTRACT

There is disclosed a payments system, comprising: a wireless computing device (AWD1); an automated teller computing machine device (AFMPD1) and a system server (AS1), the automated teller computing machine device including a respective wireless device interface module (AFMPD_INT1), in an example the automated teller computing machine device not including an end-user screen interface, in an example the automated teller computing machine device not including an end-user keypad interface. Related systems, methods, apparatus and computer program products are disclosed. An advantage is reducing the potential transaction fraud on ATM transactions or on wireless devices payment transactions.

### BACKGROUND OF THE INVENTION

### 1. Field of the Invention

The field of the invention relates to payments systems, methods, apparatus and computer program products.

### 2. Technical Background

Traditional cash deposit- and/or cash withdrawal-systems are evolving from a traditional automated teller machine (ATM), or cash machine (in British English), to more sophisticated ATMs where the security of the communication or identification of the ATM user is the main focus, to reduce fraud.

The internet and self-regulation, aided by government issued regulations and licenses, helped create the right framework for new players to operate an ATM network.

Whereas in the recent past ATMs were mainly owned and operated by traditional banks, currently any company with a minimal amount of knowledge of that industry and an ever-lower entry barrier of needed funds may operate an ATM network, which allows a lot more competition in the ATM segment.

The differences between ATM services provided by traditional providers and by new entrants differ less on the ATM services offered and instead differ more in the way the ATMs interface with end-users and the ease of scaling the number of ATMs in one or more different territories.

Despite the amazing improvements in digital ATM services and a wide variety of competing companies to choose from by end-users, there are still certain shortcomings that need to be improved or overcome.

### 3. Discussion of Related Art

Some of the shortcomings of the prior art are:
(i)—in the case of an ATM processing, most firms rely on physical cards for cash withdrawals or deposits, but this means that the card processing companies are acting as the foreign exchange firm, monies transfer firm, and the ID check firm for Anti-money laundering (AML), anti-terrorist-financing (ATF) and any such other legal compliance matters. In view that only three card companies control the global card transactions it is fair to say that competition is far from that seen in the banking or fintech industry. Therefore, technological competition to allow cash deposits and cash withdrawals also with products through non-card firms would open and aid competition and hopefully lower the barrier of entry into that massive market segment.

According to Statista:

https://www.statista.com/statistics/261327/number-of-per-card-credit-card-transactions-worldwide-by-brand-as-of-2011/

the top three card companies' transaction volumes, were respectively in Billion transactions 188, 151 and 113 out of a total global 468 billion card transactions, meaning only 3.4% of total transactions are executed by all the global card providers outside of the top three providers.
(ii)—in the case of intermediaries between end-users and card providers, such as big brands with massive reach out to users, such as for example smartphone manufacturers that control the operating systems, these intermediaries rely on a middle man approach, virtualizing the traditional physical card as an encapsulated virtual card in their own operating system to remove the need of a physical card and simply deposit or withdraw cash with a smartphone with a built-in virtual card of the top three global brands, through so called contactless Near-field communication (NFC) method, yet adding an additional so called man-in-the-middle and potentially higher cost for the ATM owner. Where the prior art improved on ease of use compared to years ago, it did not contribute to reducing the cost to ATM owners, or to increasing the revenue margin to ATM owner(s) or to those companies competing in the card companies market segment.
(iii)—in the case of an end-user, the prior art does not provide a fast clearing cash deposit or cash withdrawal method for several different reasons, namely the card processing firms in the event of a foreign exchange (FX) can apply an FX rate at different points in time of its choice and clearing to the ATM owner of the financial service provider of the ATM owner can be after the actual transaction to the end-user is confirmed, meaning after the user actually deposited or withdrew cash from a given ATM in a given country location. The card processing firm adapts the so-called executed transaction that was left in a so-called Pending state and changes over the next hours or days until it confirms the actual transaction between all the so called man (or men)-in-the-middle, leaving often users confused as to what the actual cost was at a given point in time of a given ATM transaction (deposit or withdrawal). In some countries, regulation has stepped in by authorities limiting the maximum amount in absolute value or as a percentage of the transaction amount and in some cases even limiting by law that only one financial entity is allowed to charge a cost for a single ATM transaction. This complicates the consolidation of a transaction that was done but not consolidated between all parties in the chain until a certain time after the actual transaction by the end-user.
(iv)—Another shortcoming is the potential fraud increase due to the fact a very high number of transactions are still being executed on ATMs through so called user identification through the use of a personal physical card entering a 4-digit personal identification number (PIN) number (security number). This has improved over recent times by the use of virtual cards of the major global card brands processing companies allowing smartphone operating system and other firms to become an additional man-in-the-middle by adding the card as a virtual card and accessed using end-users biometrical information. The issue is that a card with a PIN with only 4 digits is still leaving a fair amount of fraud that affects users and card brands. Also, a smartphone operating virtual card system does not have to comply with current AML, ATF legislation as they are not necessarily financial companies covered under those regulations that require a banking or fintech grade KYC (know your customer) or KYB (Know Your Business) processes.

According to Statista, the card losses in percentage are around 7.1% in 2021 of total global card transactions. When combining with the previous figures of 468 billon being the number of global card transactions, it means that roughly a massive 33 billion card transactions are potentially fraudulent in 2021.

This means that globally when using the 2023 total amount of card transactions of 45,244 billion or in other words 45 trillion $US and applying the above mentioned same 7.1% fraud in 2021, then the fraud cost to the industry when using cards in 2023 could reach around 3.2 trillion $US.

Source, https://www.paymentscardsandmobile.com/global-card-expenditure-to-reach-45-trillion/
(v).—One of the most important shortcomings impacting the financial industry, not excluding ATM card transactions or Card payment transactions is the massive amount of global financial fraud when using a card. The fact that card transactions have a limited security level of 4 digits or a potential list of lost, stolen or blocked cards sometime after they were notified provides a limited security level. The fact that the card is a passive device not capable of communicating though the internet makes it impossible to have two independent confirmations of any single transaction, meaning the card cannot confirm the user actual identity which a smartphone can do, and a card cannot confirm the user transaction data request independently to the ATM transaction data request, where both requests should be the same, thus limiting the security to just one confirmation from the ATM only. Even those ATMs that have cameras to record the user when making a transaction provide only information for after a fraud is committed and this does not prevent fraud from happening in the first place.

Although traditional ATM processing methods are perfectly workable as a business as they were profitable, the fact is that they do not provoke any major difference between traditional banks operating them compared to more recent financial firms operating them.

US2001051923 (A1), U.S. Pat. No. 7,363,274 (B2), EP1182627 (A1) and EP1182627 (B1) disclose automatic teller machines.

### SUMMARY OF THE INVENTION

We believe this invention resolves all the prior art shortcomings mentioned herein, and in particular, in an example this invention increases the security and integrity of the ATM transaction or payment processing transaction, wherein the adapted device, e.g. smartphone, after confirming the user identity authentication and the user entered amount wished to be deposited or withdrawn, it sends to the adapted system server the transaction type (e.g. cash deposit, cash withdrawal, or other) confirmation containing at least the same amount, currency and the unique transaction identifier of that specific transaction from both the adapted end-user device and sending that same information from the adapted ATM once it verifies the actual amount available in the ATM or in that user account depending on the transaction type, which is impossible to perform when such transaction would have been done with a physical card or with a wireless device not having been adapted with an example of this invention, thus reducing accordingly the potential transaction fraud on ATM transactions or on wireless devices payment transactions.

According to a first aspect of the invention, there is provided a payments system, comprising: a wireless computing device (AWD1); an automated teller computing machine device (AFMPD1) and a system server (AS1), the automated teller computing machine device including a respective wireless device interface module (AFMPD_INT1), the automated teller computing machine device not including an end-user screen interface, the automated teller computing machine device not including an end-user keypad interface, wherein:
a) the wireless computing device (AWD1), the automated teller computing machine device (AFMPD1) and the server device (AS1) are all internet enabled devices, and the wireless computing device (AWD1) includes a wireless computing device module (AWD_M1) and a wireless computing device interface (AWD_INT1);
b) the ATM device (AFMPDT) includes at least two built-in transceivers, respectively configured to connect to the internet and to connect to the wireless computing device module (AWD_M1), wherein one of the ATM transceivers is adapted to download a software module (AFMPD_M1) and a wireless device interface module (AFMPD_INT1); wherein the ATM device (AFMPD1) is automatically upon download of the software module (AFMPD_M1) configured to make the software module (AFMPD_M1) via the wireless device interface module (AFMPD_INT1) operable to communicate with the wireless computing device module (AWD_M1) through the wireless computing device interface (AWD_INT1);
c) the wireless computing device (AWD1) includes an end-user interface, and includes at least two built-in transceivers respectively configured to connect to the internet and to connect to the ATM device (AFMPD1), wherein one of the wireless computing device transceivers is adapted to download a respective software module (AWD_M1) and a wireless computing device interface module (AWD_INT1); wherein the wireless computing device (AWD1) is automatically upon download of the software module (AWD_M1) configured to make the software module (AWD_M1) through the wireless computing device interface module (AWD_INT1) operable to communicate with the ATM software module (AFMPD_M1) through the wireless device interface (AFMPD_INT1);
d) the server device (AS1, ASn) includes no direct end-user interface, wherein the server device is adapted to download or embed a respective software module (AS1_M, ASn_M); wherein the server device (AS1, ASn) is automatically upon download or embedding of the software module (AS1_M, ASn_M) configured to make the software module (AS1_M, ASn_M) operable to communicate with the ATM software module (AFMPD_M1) and with the wireless computing device module (AWD_M1), through the internet (100);
e) the ATM device (AFMPD1) including the downloaded software module (AFMPD_M1) is configured to scan through one, some or all of its available local transceivers for a communication from the wireless computing device (AWD1), wherein the wireless computing device (AWD1) with a downloaded software module (AWD_M1) is directly connectable to the Internet, wherein the transceivers of the ATM device (AFMPD1) are used only in receive mode, until the wireless computing device (AWD1) with a downloaded software module (AWD_M1) requests a communication with the ATM software module (AFMPD_M1), and then automatically in response a bidirectional Send/Receive mode of the ATM device (AFMPD1) and the wireless computing device (AWD1) is turned on; and
f) wherein the wireless computing device software module (AWD_M1), in response to receiving input from an end-user through the wireless computing device user interface, is configured to automatically request a unique transaction identifier (UTID) from the server software module (AS1_M) for a transaction with a validity timeout for that UTID, and to send user inputted data corresponding with that unique transaction identifier, including a transaction type, a transaction amount and a transaction currency, to the server software module (AS1_M), and the wireless computing device software module (AWD_M1) is configured to detect a communication from the ATM device software module (AFMPD_M1), in response to which the wireless computing device software module (AWD_M1) is configured to automatically send to the ATM device software module (AFMPD_M1) a message including at least the unique transaction identifier of that transaction, the transaction type (e.g. cash deposit, cash withdrawal, other), the transaction amount, the transaction currency, and optionally a time stamp; and
g) the ATM device (AFMPD1) is configured to determine if the wireless computing device (AWD1) is an authorized wireless computing device (AWD1) with a downloaded software module (AWD_M1), and if the ATM device (AFMPD1) determines the wireless computing device (AWD1) is an authorized wireless computing device (AWD1) with a downloaded software module (AWD_M1), then the ATM device software module (AFMPD_M1) of the ATM device (AFMPD1) is configured to auto decrypt and extract from a communication message with the wireless computing device (AWD1) the unique transaction identifier (UTID), the transaction type, the transaction amount and the transaction currency, and
h) wherein the ATM device software module (AFMPD1) is configured such that automatically upon receipt of a UTID from the wireless computing device software module (AWD_M1), the ATM device software module (AFMPD1) requests to the server software module (AS1_M) if the UTID is a valid UTID, wherein in the event of an expired UTID then the transaction is cancelled and, in the event the UTID is valid then the ATM device software module (AFMPD_M1) sends the extracted information to the server software module (AS1_M), including at least the unique transaction identifier (UTID), the transaction type, the transaction amount and the transaction currency, and optionally a time stamp and
i) wherein upon the server device module (AS1_M) receiving the last of the two separate asynchronous confirmation communications from the wireless computing device software module (AWD_M1) and the ATM device software module (AFMPD_M1), corresponding to the exact same UTID, with the same transaction type, the same transaction amount and the same transaction currency, and optionally the time stamps, then the ATM device software module (AFMPD_M1) is authorized to automatically execute the transaction, and
j) wherein the server (AS1) software module (AFMPD_M1) is configured to notify both the ATM device software module (AFMPD1_M1) and the wireless computing device (AWD1) software module (AWD_M1) of the transaction type and amount and currency having been executed, and
k) wherein the ATM device (AFMPD1) then executes the corresponding transaction type, wherein in the event of a cash deposit the ATM device (AFMPD1) then stores that cash in the ATM device (AFMPD1), and wherein in the event of a cash withdrawal the ATM device (AFMPD1) then dispenses that cash amount in a cash dispenser of the ATM device (AFMPD1) for the end-user of the wireless computing device (AWD1) to collect.

An advantage is that the ATM device of the system does not have a risk of a screen malfunction, or of showing sensitive information. An advantage is that the ATM device of the system does not have a risk of a keypad malfunction, or of revealing sensitive information during use by a user. An advantage is reducing the potential transaction fraud on ATM transactions or on wireless devices payment transactions.

The system may be one wherein in the event the money is not picked up by the end-user within a timeout or the ATM device (AFMPD1) is jammed and cannot dispense the cash then the ATM device software module (AFMPD_M1) notifies the server software module (AS1_M) and reverses the transaction and the server module (AS1_M) then notifies that the transaction is canceled to both the ATM software module (AFMPD_M1) and the wireless computing device software module (AWD_M1), and this last event triggers a notification to the end-user through the user interface of the wireless computing device (AWD1).

The system may be one wherein the automated teller computing machine device does not include a magnetic card reader. An advantage is that the ATM device of the system does not have a risk of a magnetic card reader malfunction.

The system may be one in which the wireless computing device is a mobile phone or a smartphone, wherein the wireless computing device has a transceiver enabled to connect to the internet and a different independent transceiver enabled to connect to the ATM device. An advantage is reducing the potential transaction fraud on ATM transactions or on wireless devices payment transactions.

The system may be one in which the ATM device is a fixed device with a built-in computer enabled to connect to the internet, wherein the ATM device has a transceiver enabled to connect to the wireless computing device. An advantage is reducing the potential transaction fraud on ATM transactions or on wireless devices payment transactions.

The system may be one in which the ATM device is a fixed device with a built-in computer enabled to connect to the internet.

The system may be one in which the ATM device has more than one transceiver enabled to connect to the wireless computing device.

The system may be one in which:
in the event of a cash deposit transaction type, the server makes a transfer of the amount and currency from the ATM device (AFMPD1) owner to a wallet of wireless computing device AWD1 owner,
in the event of a cash withdrawal transaction type, the server makes a transfer of the amount and currency from the wireless computing device (AWD1) owner to a wallet of the ATM device (AFMPD1) owner,
in the event of another transaction type, this is a transfer from a wallet of the paying party to a wallet of the receiving party. An advantage is reducing the potential transaction fraud on ATM transactions or on wireless devices payment transactions.

The system may be one in which the transaction amount can be in any asset class, be it traditional currency (EUR, GBP, USD, MXN, BRL, etc), crypto currency (BTC, ETH, ADA, BNB, USDT, etc), shares, tokens, exchange traded fund units, equity, bonds, loyalty points.

The system may be one in which the communication interfaces (AWD_INT1) of wireless computing device (AWD1) and interface (AFMPD_INT1) of ATM device (AFMPD1) are arranged to use one or more of: bidirectional near field communications (NFC), bidirectional non-audible frequency band communications, bidirectional non-visible light band communications. An advantage is reducing the potential transaction fraud on ATM transactions or on wireless devices payment transactions.

The system may be one in which the automated teller computing machine device includes no end-user interface. An advantage is that the ATM device of the system does not have a risk of an end-user interface malfunction, or that the end-user interface can reveal sensitive information.

According to a second aspect of the invention, there is provided a payments system, comprising: a wireless computing device (AWD1); an automated teller computing machine device (AFMPD1) and a system server (AS1), the automated teller computing machine device including a respective wireless device interface module (AFMPD_INT1), the automated teller computing machine device including an end-user interface, wherein:
a) the wireless computing device (AWD1), the automated teller computing machine device (AFMPD1) and the server device (AS1) are all internet enabled devices, and the wireless computing device (AWD1) includes a wireless computing device module (AWD_M1) and a wireless computing device interface (AWD_INT1);
b) the ATM device (AFMPD1) includes at least two built-in transceivers, respectively configured to connect to the internet and to connect to the wireless computing device module (AWD_M1), wherein one of the ATM transceivers is adapted to download a software module (AFMPD_M1) and a wireless device interface module (AFMPD_INT1); wherein the ATM device (AFMPD1) is automatically upon download of the software module (AFMPD_M1) configured to make the software module (AFMPD_M1) via the wireless device interface module (AFMPD_INT1) operable to communicate with the wireless computing device module (AWD_M1) through the wireless computing device interface (AWD_INT1);
c) the wireless computing device (AWD1) includes an end-user interface, and includes at least two built-in transceivers respectively configured to connect to the internet and to connect to the ATM device (AFMPD1), wherein one of the wireless computing device transceivers is adapted to download a respective software module (AWD_M1) and a wireless computing device interface module (AWD_INT1); wherein the wireless computing device (AWD1) is automatically upon download of the software module (AWD_M1) configured to make the software module (AWD_M1) through the wireless computing device interface module (AWD_INT1) operable to communicate with the ATM software module (AFMPD_M1) through the wireless device interface (AFMPD_INT1);
d) the server device (AS1, ASn) includes no direct end-user interface, wherein the server device is adapted to download or embed a respective software module (AS1_M, ASn_M); wherein the server device (AS1, ASn) is automatically upon download or embedding of the software module (AS1_M, ASn_M) configured to make the software module (AS1_M, ASn_M) operable to communicate with the ATM software module (AFMPD_M1) and with the wireless computing device module (AWD_M1), through the internet (100);
e) the ATM device (AFMPD1) including the downloaded software module (AFMPD_M1) is configured to scan through one, some or all of its available local transceivers for a communication from the wireless computing device (AWD1), wherein the wireless computing device (AWD1) with a downloaded software module (AWD_M1) is directly connectable to the Internet, wherein the transceivers of the ATM device (AFMPD1) are used only in receive mode, until the wireless computing device (AWD1) with a downloaded software module (AWD_M1) requests a communication with the ATM software module (AFMPD_M1), and then automatically in response a bidirectional Send/Receive mode of the ATM device (AFMPD1) and the wireless computing device (AWD1) is turned on; and
f) wherein the wireless computing device software module (AWD_M1), in response to receiving input from an end-user through the wireless computing device user interface, is configured to automatically request a unique transaction identifier (UTID) from the server software module (AS1_M) for a transaction with a validity timeout for that UTID, and to send user inputted data corresponding with that unique transaction identifier, including a transaction type, a transaction amount and a transaction currency, to the server software module (AS1_M), and the wireless computing device software module (AWD_M1) is configured to detect a communication from the ATM device software module (AFMPD_M1), in response to which the wireless computing device software module (AWD_M1) is configured to automatically send to the ATM device software module (AFMPD_M1) a message including at least the unique transaction identifier of that transaction, the transaction type (e.g. cash deposit, cash withdrawal, other), the transaction amount, the transaction currency, and optionally a time stamp; and
g) the ATM device (AFMPD1) is configured to determine if the wireless computing device (AWD1) is an authorized wireless computing device (AWD1) with a downloaded software module (AWD_M1), and if the ATM device (AFMPD1) determines the wireless computing device (AWD1) is an authorized wireless computing device (AWD1) with a downloaded software module (AWD_M1), then the ATM device software module (AFMPD_M1) of the ATM device (AFMPD1) is configured to auto decrypt and extract from a communication message with the wireless computing device (AWD1) the unique transaction identifier (UTID), the transaction type, the transaction amount and the transaction currency, and
h) wherein the ATM device software module (AFMPD1) is configured such that automatically upon receipt of a UTID from the wireless computing device software module (AWD_M1), the ATM device software module (AFMPD1) requests to the server software module (AS1_M) if the UTID is a valid UTID, wherein in the event of an expired UTID then the transaction is cancelled and, in the event the UTID is valid then the ATM device software module (AFMPD_M1) sends the extracted information to the server software module (AS1_M), including at least the unique transaction identifier (UTID), the transaction type, the transaction amount and the transaction currency, and optionally a time stamp and
i) wherein upon the server device module (AS1_M) receiving the last of the two separate asynchronous confirmation communications from the wireless computing device software module (AWD_M1) and the ATM device software module (AFMPD_M1), corresponding to the exact same UTID, with the same transaction type, the same transaction amount and the same transaction currency, and optionally the time stamps, then the ATM device software module (AFMPD_M1) is authorized to automatically execute the transaction, and
j) wherein the server (AS1) software module (AFMPD_M1) is configured to notify both the ATM device software module (AFMPD1_M1) and the wireless computing device (AWD1) software module (AWD_M1) of the transaction type and amount and currency having been executed, and
k) wherein the ATM device (AFMPD1) then executes the corresponding transaction type, wherein in the event of a cash deposit the ATM device (AFMPD1) then stores that cash in the ATM device (AFMPD1), and wherein in the event of a cash withdrawal the ATM device (AFMPD1) then dispenses that cash amount in a cash dispenser of the ATM device (AFMPD1) for the end-user of the wireless computing device (AWD1) to collect.

An advantage is reducing the potential transaction fraud on ATM transactions or on wireless devices payment transactions.

The system may be one wherein in the event the money is not picked up by the end-user within a timeout or the ATM device (AFMPD1) is jammed and cannot dispense the cash then the ATM device software module (AFMPD_M1) notifies the server software module (AS1_M) and reverses the transaction and the server module (AS1_M) then notifies that the transaction is canceled to both the ATM software module (AFMPD_M1) and the wireless computing device software module (AWD_M1), and this last event triggers a notification to the end-user through the user interface of the wireless computing device (AWD1).

The system may be one wherein the automated teller computing machine device does not include a magnetic card reader. An advantage is that the ATM device of the system does not have a risk of a magnetic card reader malfunction.

The system may be one in which the wireless computing device is a mobile phone or a smartphone, wherein the wireless computing device has a transceiver enabled to connect to the internet and a different independent transceiver enabled to connect to the ATM device. An advantage is reducing the potential transaction fraud on ATM transactions or on wireless devices payment transactions.

The system may be one in which the ATM device is a fixed device with a built-in computer enabled to connect to the internet, wherein the ATM device has a transceiver enabled to connect to the wireless computing device. An advantage is reducing the potential transaction fraud on ATM transactions or on wireless devices payment transactions.

The system may be one in which the ATM device is a fixed device with a built-in computer enabled to connect to the internet.

The system may be one in which the ATM device has more than one transceiver enabled to connect to the wireless computing device.

The system may be one in which:
in the event of a cash deposit transaction type, the server makes a transfer of the amount and currency from the ATM device (AFMPD1) owner to a wallet of wireless computing device AWD1 owner,
in the event of a cash withdrawal transaction type, the server makes a transfer of the amount and currency from the wireless computing device (AWD1) owner to a wallet of the ATM device (AFMPD1) owner,
in the event of another transaction type, this is a transfer from a wallet of the paying party to a wallet of the receiving party. An advantage is reducing the potential transaction fraud on ATM transactions or on wireless devices payment transactions.

The system may be one in which the transaction amount can be in any asset class, be it traditional currency (EUR, GBP, USD, MXN, BRL, etc), crypto currency (BTC, ETH, ADA, BNB, USDT, etc), shares, tokens, exchange traded fund units, equity, bonds, loyalty points.

The system may be one in which the communication interfaces (AWD_INT1) of wireless computing device (AWD1) and interface (AFMPD_INT1) of ATM device (AFMPD1) are arranged to use one or more of: bidirectional near field communications (NFC), bidirectional non-audible frequency band communications, bidirectional non-visible light band communications. An advantage is reducing the potential transaction fraud on ATM transactions or on wireless devices payment transactions.

According to a third aspect of the invention, there is provided a computer-implemented method of executing a fraud-resistant transaction type, the method using a payments system, comprising: a wireless computing device (AWD1); an automated teller computing machine device (AFMPD1) and a system server (AS1), the automated teller computing machine device including a respective wireless device interface module (AFMPD_INT1), the automated teller computing machine device not including an end-user screen interface, the automated teller computing machine device not including an end-user keypad interface;

wherein the wireless computing device (AWD1), the automated teller computing machine device (AFMPD1) and the server device (AS1) are all internet enabled devices, and the wireless computing device (AWD1) includes a wireless computing device module (AWD_M1) and a wireless computing device interface (AWD_INT1);
wherein the ATM device (AFMPD1) includes at least two built-in transceivers, respectively configured to connect to the internet and to connect to the wireless computing device module (AWD_M1); the wireless computing device (AWD1) including an end-user interface, the server device (AS1, ASn) including no direct end-user interface, the method including the steps of:
(i) one of the ATM transceivers downloading a software module (AFMPD_M1) and a wireless device interface module (AFMPD_INT1); the ATM device (AFMPD1) automatically upon download of the software module (AFMPD_M1) making the software module (AFMPD_M1) via the wireless device interface module (AFMPD_INT1) operable to communicate with the wireless computing device module (AWD_M1) through the wireless computing device interface (AWD_INT1);
ii), at least two built-in transceivers of the wireless computing device connecting to the internet and connecting to the ATM device (AFMPD1), wherein one of the wireless computing device transceivers downloads a respective software module (AWD_M1) and a wireless computing device interface module (AWD_INT1); wherein the wireless computing device (AWD1) automatically upon download of the software module (AWD_M1) makes the software module (AWD_M1) through the wireless computing device interface module (AWD_INT1) operable to communicate with the ATM software module (AFMPD_M1) through the wireless device interface (AFMPD_INT1);
iii) the server device downloading or embedding a respective software module (AS1_M, ASn_M); wherein the server device (AS1, ASn) automatically upon download or embedding of the software module (AS1_M, ASn_M) makes the software module (AS1_M, ASn_M) operable to communicate with the ATM software module (AFMPD_M1) and with the wireless computing device module (AWD_M1), through the internet (100);
iv) the ATM device (AFMPD1) including the downloaded software module (AFMPD_M1) scanning through one, some or all of its available local transceivers for a communication from the wireless computing device (AWD1), wherein the wireless computing device (AWD1) with a downloaded software module (AWD_M1) directly connects to the Internet, wherein the transceivers of the ATM device (AFMPD1) are used only in receive mode, until the wireless computing device (AWD1) with a downloaded software module (AWD_M1) requests a communication with the ATM software module (AFMPD_M1), and then automatically in response a bidirectional Send/Receive mode of the ATM device (AFMPD1) and the wireless computing device (AWD1) is turned on; and
v) wherein the wireless computing device software module (AWD_M1), in response to receiving input from an end-user through the wireless computing device user interface, automatically requests a unique transaction identifier (UTID) from the server software module (AS1_M) for a transaction with a validity timeout for that UTID, sends user inputted data corresponding with that unique transaction identifier, including a transaction type, a transaction amount and a transaction currency, to the server software module (AS1_M), and the wireless computing device software module (AWD_M1) detects a communication from the ATM device software module (AFMPD_M1), in response to which the wireless computing device software module (AWD_M1) automatically sends to the ATM device software module (AFMPD_M1) a message including at least the unique transaction identifier of that transaction, the transaction type (e.g. cash deposit, cash withdrawal, other), the transaction amount, the transaction currency, and optionally a time stamp; and
vi) the ATM device (AFMPD1) determines if the wireless computing device (AWD1) is an authorized wireless computing device (AWD1) with a downloaded software module (AWD_M1), and if the ATM device (AFMPD1) determines the wireless computing device (AWD1) is an authorized wireless computing device (AWD1) with a downloaded software module (AWD_M1), then the ATM device software module (AFMPD_M1) of the ATM device (AFMPDT) auto decrypts and extracts from a communication message with the wireless computing device (AWD1) the unique transaction identifier (UTID), the transaction type, the transaction amount and the transaction currency, and
vii) wherein automatically upon receipt of a UTID from the wireless computing device software module (AWD_M1), the ATM device software module (AFMPD1) requests to the server software module (AS1_M) if the UTID is a valid UTID, wherein in the event of an expired UTID then the transaction is cancelled and, in the event the UTID is valid then the ATM device software module (AFMPD_M1) sends the extracted information to the server software module (AS1_M), including at least the unique transaction identifier (UTID), the transaction type, the transaction amount and the transaction currency, and optionally a time stamp and
viii) wherein upon the server device module (AS1_M) receiving the last of the two separate asynchronous confirmation communications from the wireless computing device software module (AWD_M1) and the ATM device software module (AFMPD_M1), corresponding to the exact same UTID, with the same transaction type, the same transaction amount and the same transaction currency, and optionally the time stamps, then the ATM device software module (AFMPD_M1) is authorized by the server device module to automatically execute the transaction, and
ix) wherein the server (AS1) software module (AFMPD_M1) notifies both the ATM device software module (AFMPD1_M1) and the wireless computing device (AWD1) software module (AWD_M1) of the transaction type and amount and currency having been executed, and
x) wherein the ATM device (AFMPD1) then executes the corresponding transaction type, wherein in the event of a cash deposit the ATM device (AFMPD1) then stores that cash in the ATM device (AFMPD1), and wherein in the event of a cash withdrawal the ATM device (AFMPD1) then dispenses that cash amount in a cash dispenser of the ATM device (AFMPD1) for the end-user of the wireless computing device (AWD1) to collect.

An advantage is that the ATM device of the method does not have a risk of a screen malfunction, or of showing sensitive information. An advantage is that the ATM device of the method does not have a risk of a keypad malfunction, or of revealing sensitive information during use by a user. An advantage is reducing the potential transaction fraud on ATM transactions or on wireless devices payment transactions.

The method may be one including using a system of any aspect of the first aspect of the invention.

According to a fourth aspect of the invention, there is provided a computer-implemented method of executing a fraud-resistant transaction type, the method using a payments system, comprising: a wireless computing device (AWD1); an automated teller computing machine device (AFMPD1) and a system server (AS1), the automated teller computing machine device including a respective wireless device interface module (AFMPD_INT1), the automated teller computing machine device including an end-user interface, wherein the wireless computing device (AWD1), the automated teller computing machine device (AFMPD1) and the server device (AS1) are all internet enabled devices, and the wireless computing device (AWD1) includes a wireless computing device module (AWD_M1) and a wireless computing device interface (AWD_INT1); wherein the ATM device (AFMPD1) includes at least two built-in transceivers, respectively configured to connect to the internet and to connect to the wireless computing device module (AWD_M1), the wireless computing device (AWD1) including an end-user interface, and including at least two built-in transceivers respectively configured to connect to the internet and to connect to the ATM device (AFMPD1), the server device (AS1, ASn) including no direct end-user interface, the method including the steps of:
(i) one of the ATM transceivers downloading a software module (AFMPD_M1) and a wireless device interface module (AFMPD_INT1); automatically upon download of the software module (AFMPD_M1) making the software module (AFMPD_M1) via the wireless device interface module (AFMPD_INT1) operable to communicate with the wireless computing device module (AWD_M1) through the wireless computing device interface (AWD_INT1);
ii) one of the wireless computing device transceivers downloading a respective software module (AWD_M1) and a wireless computing device interface module (AWD_INT1); the wireless computing device (AWD1) automatically making the software module (AWD_M1) through the wireless computing device interface module (AWD_INT1) operable to communicate with the ATM software module (AFMPD_M1) through the wireless device interface (AFMPD_INT1);
iii), the server device downloading or embedding a respective software module (AS1_M, ASn_M); the server device (AS1, ASn) automatically making the software module (AS1_M, ASn_M) operable to communicate with the ATM software module (AFMPD_M1) and with the wireless computing device module (AWD_M1), through the internet (100);
iv) the ATM device (AFMPD1) including the downloaded software module (AFMPD_M1) scanning through one, some or all of its available local transceivers for a communication from the wireless computing device (AWD1), the wireless computing device (AWD1) with a downloaded software module (AWD_M1) directly connecting to the Internet, wherein the transceivers of the ATM device (AFMPD1) are used only in receive mode, until the wireless computing device (AWD1) with a downloaded software module (AWD_M1) requests a communication with the ATM software module (AFMPD_M1), and then automatically in response a bidirectional Send/Receive mode of the ATM device (AFMPD1) and the wireless computing device (AWD1) is turned on; and
v) the wireless computing device software module (AWD_M1), in response to receiving input from an end-user through the wireless computing device user interface, automatically requests a unique transaction identifier (UTID) from the server software module (AS1_M) for a transaction with a validity timeout for that UTID, sends user inputted data corresponding with that unique transaction identifier, including a transaction type, a transaction amount and a transaction currency, to the server software module (AS1_M), and the wireless computing device software module (AWD_M1) detects a communication from the ATM device software module (AFMPD_M1), in response to which the wireless computing device software module (AWD_M1) automatically sends to the ATM device software module (AFMPD_M1) a message including at least the unique transaction identifier of that transaction, the transaction type (e.g. cash deposit, cash withdrawal, other), the transaction amount, the transaction currency, and optionally a time stamp; and
vi) the ATM device (AFMPD1) determines if the wireless computing device (AWD1) is an authorized wireless computing device (AWD1) with a downloaded software module (AWD_M1), and if the ATM device (AFMPD1) determines the wireless computing device (AWD1) is an authorized wireless computing device (AWD1) with a downloaded software module (AWD_M1), then the ATM device software module (AFMPD_M1) of the ATM device (AFMPD1) auto decrypts and extracts from a communication message with the wireless computing device (AWD1) the unique transaction identifier (UTID), the transaction type, the transaction amount and the transaction currency, and
vii) automatically upon receipt of a UTID from the wireless computing device software module (AWD_M1), the ATM device software module (AFMPD1) requests to the server software module (AS1_M) if the UTID is a valid UTID, wherein in the event of an expired UTID then the transaction is cancelled and, in the event the UTID is valid then the ATM device software module (AFMPD_M1) sends the extracted information to the server software module (AS1_M), including at least the unique transaction identifier (UTID), the transaction type, the transaction amount and the transaction currency, and optionally a time stamp and
viii) upon the server device module (AS1_M) receiving the last of the two separate asynchronous confirmation communications from the wireless computing device software module (AWD_M1) and the ATM device software module (AFMPD_M1), corresponding to the exact same UTID, with the same transaction type, the same transaction amount and the same transaction currency, and optionally the time stamps, then the ATM device software module (AFMPD_M1) is authorized to automatically execute the transaction, and
ix) the server (AS1) software module (AFMPD_M1) notifying both the ATM device software module (AFMPD1_M1) and the wireless computing device (AWD1) software module (AWD_M1) of the transaction type and amount and currency having been executed, and
x) the ATM device (AFMPD1) then executes the corresponding transaction type, wherein in the event of a cash deposit the ATM device (AFMPD1) then stores that cash in the ATM device (AFMPD1), and wherein in the event of a cash withdrawal the ATM device (AFMPD1) then dispenses that cash amount in a cash dispenser of the ATM device (AFMPD1) for the end-user of the wireless computing device (AWD1) to collect.

An advantage is reducing the potential transaction fraud on ATM transactions or on wireless devices payment transactions.

The method may be one including using a system of any aspect according to the second aspect of the invention.

According to a fifth aspect of the invention, there is provided an automated teller computing machine device (AFMPD1) including the automated teller computing machine device software module (AFMPD_M1) and the automated teller computing machine device wireless device interface module (AFMPD_INT1) of any aspect of the first or second aspects of the invention.

According to a sixth aspect of the invention, there is provided a wireless computing device (AWD1)) including the wireless computing device software module (AWD_M1) and the wireless computing device interface module (AWD_INT1) of any aspect of the first or second aspects of the invention.

According to a seventh aspect of the invention, there is provided a system server (AS1) including the server device software module (AS1_M, ASn_M) of any aspect of the first or second aspects of the invention.

According to an eighth aspect of the invention, there is provided a set of computer program products, including the automated teller computing machine device software module (AFMPD_M1), the automated teller computing machine device wireless device interface module (AFMPD_INT1), the wireless computing device software module (AWD_M1), the wireless computing device interface module (AWD_INT1), and the server device software module (AS1_M, ASn_M) of any aspect of the first or second aspects of the invention.

According to a ninth aspect of the invention, there is provided a set of computer program products, including the automated teller computing machine device software module (AFMPD_M1), and the automated teller computing machine device wireless device interface module (AFMPD_INT1) of any aspect of the first or second aspects of the invention.

According to a tenth aspect of the invention, there is provided a set of computer program products, including the wireless computing device software module (AWD_M1), and the wireless computing device interface module (AWD_INT1) of any aspect of the first or second aspects of the invention.

According to an eleventh aspect of the invention, there is provided a computer program product, wherein the computer program product is the server device software module (AS1_M, ASn_M) of any aspect of the first or second aspects of the invention.

Aspects of the invention may be combined.

### BRIEF DESCRIPTION OF THE FIGURES

Aspects of the invention will now be described, by way of example(s), with reference to the following Figures, in which:

FIG. 1 represents a diagram of a typical example of the present invention, forming an ATM transactions system or a payments transactions processing system. It comprises adapted wireless devices (AWD0 to AWDn), adapted fixed money processing devices (AFMPD1 to AFMPDn) and adapted servers (AS1 to ASn), where AS1 to ASn could be integrated as one and the same server or as separate independent different geolocated cloud-based servers communicated between them through the internet. Any such adapted fixed money processing devices can be an ATM (automated teller machine), meaning a machine in a fixed location connected through the internet to the corresponding payments processing server directly (AS1 and AS2 combined as one server) or through an intermediary ATM transactions processing server (AS2) to the payments processing server (AS1), respectively communicating between them through communication channel 400.1 through the internet to 400.2 or through 400.4 through the internet to 400.3 as an encrypted bidirectional channel. Any such adapted wireless devices can be a mobile phone, tablet, smartphone or any such other device enabled to download an Application Module (AWD_M1 to AWD_Mn) and enables the adapted wireless device through the adapted mobile interface (AWD_INT1) to AWD_INTn) to communicate with the “mobile interface” (AFMPD_INT1 to AFMPD_INTn) of the “adapted fixed money processing devices” or “adapted ATMs” (AATMs) through the encrypted bidirectional communications channels 400.0 and 400.5.

FIG. 2 represents a functional block diagram or flow-chart of an example communication method between the adapted Wireless Devices (AWD) and the adapted ATM devices (AATM) and the user interface example of the present invention, wherein, the start of the process is by the user clicking on a dedicated key on the AATM screen to switch the standard ATM function to the adapted ATM function in line with this invention. The user is given a timeout to initiate a specific transaction type (example, cash deposit or cash withdrawal, or other) by bringing his adapted wireless device (AWD) in very close proximity of the AATM interface.

FIG. 3 represents the detailed flow-chart of one of the examples of the present invention for the “device detection module” of previous FIG. 2.

FIG. 4 represents the detailed flow-chart of one of the examples of the present invention for the “cash deposit process” module of FIG. 2.

FIG. 5 represents the detailed flow-chart of one of the examples of the present invention for the “cash withdrawal process” module of FIG. 2.

FIG. 6 represents the detailed flow-chart of one of the examples of the present invention for the “other processes” module of FIG. 2.

FIG. 7 represents an example detailed interfaces communications protocol between the adapted device (AS1) as one of the examples of the present invention for the “handshake protocol”.

FIG. 8 represents an example of the detailed content of the message exchanged between the adapted wireless device (AWD1) and the adapted ATM device (AFMPD1) from which the “handshake protocol”.

FIG. 9 represents an example of the detailed content of the message payload exchanged as part of the “message” between the adapted wireless device (AWD1) and the adapted ATM device (AFMPD1).

FIG. 10 shows a block diagram showing a structure of an automatic teller machine according to prior art publication EP1182627 (A1).

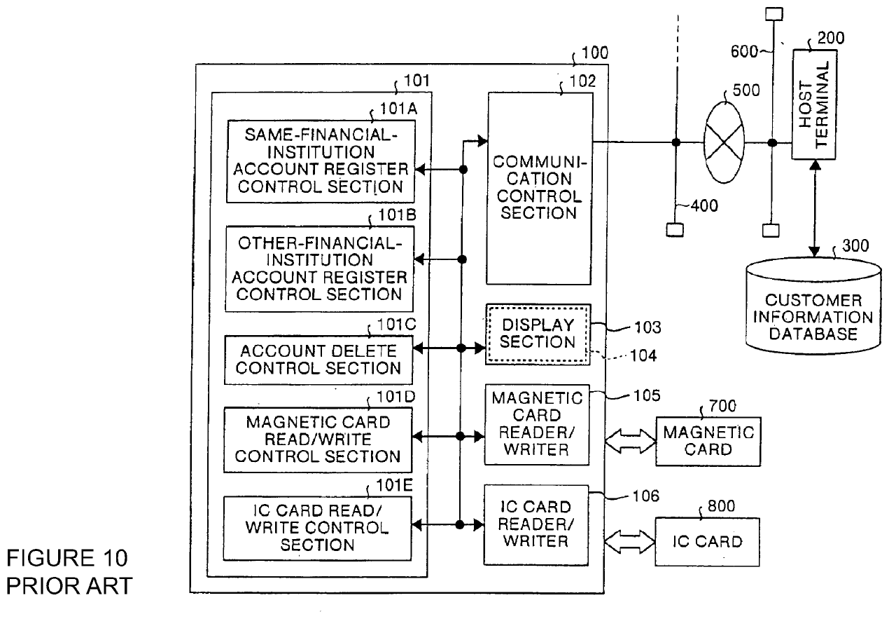

### DETAILED DESCRIPTION

The present invention has been developed to solve the current real issues for ATM companies and non-card payment processing companies alike, by resolving issues such as (i) improving transactions margins to ATM companies and/or non-card payment processing companies, (ii) reducing the number of middle men in the payments transactions process flow between the user performing a cash deposit or cash withdrawal transaction on an adapted ATM and the actual clearance of the monies and margins of the overall transaction process, (iii) reducing the hurdles for end-users to access financial services as part of financial inclusion for underserved or unbanked users giving them a way to make their first ever and/or consequent cash deposits, (iv) improving access to electronic money by end-users who don't have cards, (v) reducing or potentially removing the financial risk on potential fraud when using a card during an ATM transaction by not using a card at all on an adapted ATM of this invention, (vi) reduce the time between clearing transaction funds and margins between the companies involved in the ATM cash-deposit and/or cash withdrawal flow by using the method or system of this invention, requiring the use of adapted wireless devices and the adapted ATMs.

The present invention is developed to overcome the shortcomings of the prior art and to offer the ATM industry and payments industry an automated way of resolving the shortcomings of the prior art specifically for cash-deposit and cash-withdrawals by the use of adapted wireless devices capable of communicating with adapted ATM devices, and each of those adapted devices communicating with an adapted system server by secure connections through the internet. Such adapted wireless devices may communicate with the adapted ATMs through an encrypted adapted communication protocol that both the adapted wireless device and the wireless ATM understand.

The adapted wireless devices herein are those smartphones, tablets and any such other different devices that downloaded a custom module of an example of this invention.

In an example, there is provided a system and method of operating a payments system using an Adapted Wireless Device (AWD) in combination with an Adapted ATM (AATM), communicating with each other through a Secure Adapted Protocol (SAP) and communicating through a secure connection through the internet with their corresponding adapted system server, jointly forming a novel ATM- and/or payments-system or method. This example of the invention improves on the prior art shortcomings allowing companies operating ATMs and/or payment processing companies an alternative innovative and competitive choice of using this example of the invention and bringing the cost of entry into these market segments down by bringing more competition in the ATM operators industry and in the payments-industry. Currently the payments-industry is dominated by just three companies globally. Additionally, this example of the invention reduces the potential for users' fraud by eliminating the use of cards and increasing the authentication security process, by requiring an end-user adapted wireless device to authenticate through the device by two factor authentication, or by multi-factor authentication, and/or by biometrical identification verification, wherein all users are prior screened through a banking- or fintech-grade KYC/KYB process. Moreover, this example of the invention increases the security and integrity of the actual transaction (e.g. payment transfer, cash deposit, cash withdrawal, or other) by requiring a transaction type confirmation of the same amount, currency and unique transaction identifier separately from both the adapted end-user device and from the adapted ATM, sent to the adapted system server, which is impossible to perform when such transaction would have been done with a physical card, thus reducing accordingly the potential transaction fraud on ATM transactions and on payment online or point of sale payments.

In an example, there is provided a system and method of operating a payments system to automate certain cash-deposit and cash-withdrawal processing aspects through the use of adapted wireless devices- (AWS) and adapted ATMs- (AATM), wherein an adapted ATM is an adapted Automated Teller Machine, adapted as per an example of this invention. Aspects of the disclosures relate in particular to a system and method of enabling a Wallet-Cash-Device “WCD”, also referred to as an “AWS” to be part of a cash-deposit & cash-withdrawal system in order to allow wireless devices, adapted as per an example of this invention, to act as a Wallet-Cash-Device “WCD” where such WCD or AWS can be a mobile phone-, smartphone-, or wireless device—adapted as per an example of this invention to facilitate cash-deposits and cash-withdrawals using “WCD” interfaces with an adapted ATM (AATM), and where such ATM communicates through a secure encrypted virtual private network (VPN) with the server that manages the ATM processing of all the transactions of all ATMs connected to that ATM server. The ATM server in turn communicates with the cloud server with which the smartphones or WCDs communicate, to execute the actual transaction of cash-deposit or cash-withdrawal directly from and to the wallets of the smartphone or WCD users and/or the ATM wallet.

Other aspects of disclosures include enabling those adapted wireless devices (WCDs) as per examples of this invention to perform payments or receive payments through the Custom-Made-Device.

Secure transaction communications between adapted wireless devices and the system servers are facilitated through the wireless devices communicating with the adapted ATM through a proprietary interface protocol wherein the distance between the wireless device interface and the ATM interface is less than the range for an ultra-low power transmission, in the range of 10 cm or less, and with a bit error rate low enough to ensure a reliable communication between those devices, thus each of the wireless device and the ATM communicate with each other through the proprietary interface protocol “PIP”.

This way a single transaction initiated by an end-user through his adapted wireless device “AWD”, requires the server to receive a separate request from the user's wireless device and the adapted ATM “AATM” containing a same unique transaction identifier be they with a same or different time-stamp. Each of those transaction requests is created as follows:
a single adapted wireless device “AWD” (i) authenticates the AWD user and auto-logs-in and the user enters on the AWD his request to deposit cash or to withdraw cash and the amount and (ii) clicks on the adapted ATM “AATM” screen on a custom key, hereinafter referred to as the “TT” key and then after that (iii) confirms that request through the adapted ATM “AATM” by putting the AWD interface near the corresponding same AATM interface. The order of previous points (i) and (ii) may be in reverse order but, in an example, both are mandatory before continuing to step (iii).
a.—in the case of a cash deposit initiated by the end-user:
The AATM will detect automatically from the communication protocol between the AWD and the AATM, to show on screen the amount the user wanted to deposit and, in the background, the AATM checks if that amount is acceptable to be deposited depending on the physical space for such amount, if the check is positive the user will be prompted on screen to insert the bills and the AATM shows on screen the amount inserted. If the amount counted by the AATM is the same as the amount entered by the user on his AWD then the AATM connects with the AATM server, through a secure VPN connection. If the amount is different then that operation will be cancelled and the AATM returns the money to the end-user. If the amount is correct, the AATM server connects by a proprietary API to the AWD server and communicates the same amount & currency that it has inside the AATM machine and the unique transaction ID “UTID” of that Cash Deposit operation. This means that the AWD server received two communications with the same unique transaction ID “UTID” and the same amount and currency, one from the AWD and one from the AATM. If only one of the two communications is received by the AWD server, then after a time-out it will cancel such a transaction. The communications from the AWD and the AATM server with the AWD server are asynchronous and can arrive at different times, but must be within the AWD server set time-out period, for example within 5 minutes. If the two communications with the same UTID have been received by the AWD server, then the AWD server makes a transfer of such amount & currency from the AATM escrow wallet/account controlled by the AWD server to the end-user wallet/account controlled by the AWD server. The AWD server optionally will confirm the receipt of such funds before communicating such transfer receipt confirmation to the corresponding AATM application programming interface (API) communication such that the AATM confirms the completion of such cash deposit being in the end-user wallet AND in parallel the AWD server communicates the same confirmation that such amount & currency corresponding to the cash deposit is now available in the end-user's wallet and are ready for his use of such funds.
b.—in the case of a cash withdrawal initiated by the end-user:
The AATM will detect automatically from the communication protocol between the AWD and the AATM, to show on screen the amount the user wanted to withdraw and, in the background, the AATM checks if that amount is acceptable to be withdrawn depending on such physical amount being available in the AATM, and if the check is positive the user will be prompted on screen to wait a moment for the bills to appear in the cash dispenser and the AATM shows on screen the amount that will be dispensed. If the cash amount available inside the AATM is more than the amount entered by the user on his AWD, then the AATM connects with the AATM server, through a secure VPN connection. If the cash amount is less, then that operation will be cancelled and the AATM informs the AWD server and goes back to the home screen. If the amount is acceptable, then the AATM server connects by a proprietary API to the AWD server and communicates the same amount & currency that the AWD communicated to the AATM together with the unique transaction ID “UTID” of that Cash withdrawal operation. This means that the AWD server received two communications with the same unique transaction ID “UTID” and the same amount and currency, one from the AWD and one from the AATM. If only one of the two communications is received by the AWD server, then after a time-out it will cancel such a transaction. The communications from the AWD and the AATM server with the AWD server are asynchronous and can arrive at different times, but must be within the AWD server set time-out period, for example within 5 minutes. If the two communications with the same UTID have been received by the AWD server, then the AWD server makes a transfer of such amount & currency from the AWD end-user wallet/account controlled by the AWD server to the AATM escrow wallet/account controlled by the AWD server. The AWD server optionally will confirm the receipt of such funds before communicating such transfer receipt confirmation to the corresponding AATM API communication such that the AATM confirms the completion of such cash withdrawal transfer being in the AATM wallet AND in parallel the AWD server communicates the same confirmation that such amount & currency corresponding to the cash withdrawal is now taken (i.e. debited) from the end-user's wallet and such monies are now ready to be taken in cash from the corresponding AATM cash dispenser. The AATM will dispense the cash amount immediately after it receives a confirmation from the AATM server, confirming that it received a confirmation from the AWD server that the same amount to be cash withdrawn has been transferred or has been confirmed checked to be in the escrow wallet/account of the AATM owner. In this way the financial risk has been removed or minimized to both the AWD server owner and the AATM owner.
c.—If, however for whatever reason, the AATM incoming cash counter or outgoing cash dispenser detects an error, then the operation will be cancelled, and the corresponding transfer will be reversed by the AWD server.
d.—The wallet/account controlled by the AWD server of the AATM owner can be a standard traditional bank account or also referred to as a fiat wallet of a given currency (such as but not limited EURO, GBP, USD, MXN, etc.), or can be a crypto wallet of a given digital currency such as stable coins (USDT, ESDC, etc.), CBDC (central bank digital currency), or any such blockchain based crypto assets (such as but not limited to (Bitcoin, Ethereum, Cardano, Binance Coin, Dash etc.).
e.—in a different example of the present invention, the AATMs can be from different companies owning a group of AATMs in a single country or in different countries or regions, but all AATM owners must have an escrow account/wallet with the AWD server owner(s) as a preferred example of the present invention as no-platform transactions are virtually instant and allow verification that funds have cleared in the receiving wallet prior to confirming a cash transaction or optionally provide their wallet/account direct debit instructions to the AWD server to allow the AWD server to transfer to such AATM wallet or to debit from such AATM wallet.
f.—in a different example of the present invention, the AWD server(s) can be from different companies with end-users in a single country or in different countries or regions, but all AWD server owners must have an escrow account/wallet with the lead AWD server owner(s), where such lead AWD server is the only one making the actual transactions to and from the different AWD servers wallet of different companies and the AATM server wallets of different companies, whereas each individual AWD server then executes the corresponding same amount to and from their own end-user that initiated the actual transaction with a given AWD.
g.—it is important to note that in order to comply with applicable regulations of AML (anti-money-laundering) and ATF (anti-terrorist-financing) that all end-users of each AWD are properly identified in line with industry practices, meaning having passed a proper KYC (know-your-customer) process in case of individuals or a KYB (know-your-business) in case of a business using an AWD.
h.—in a different example of the present invention the communication method between the AWD and the AATM are through a proprietary communications protocol through a digital channel or an analogue to digital converter and vice-versa channel. It is imperative for security reasons and to avoid real time hacking or sniffing of the actual communication channel between the AWD and the AATM that the range of the communication method is limited to very short distances, for example up to 10 cm through NFC (near field communications), BLE (Bluetooth low energy) or Ultrasound audio or light emitted communications or any such other ultra-low range two-way communications technology. Different ways of limiting the communication range, is by limiting the transmission output power of the used method (in example NFC, BLE, audio) or to make use of proprietary directional methods of channeling the energy through mechanical shielded guides or tunnels, where the exit of the AWD tunnel has to be literally in front of the entrance of the AATM tunnel, in example for audio or light).

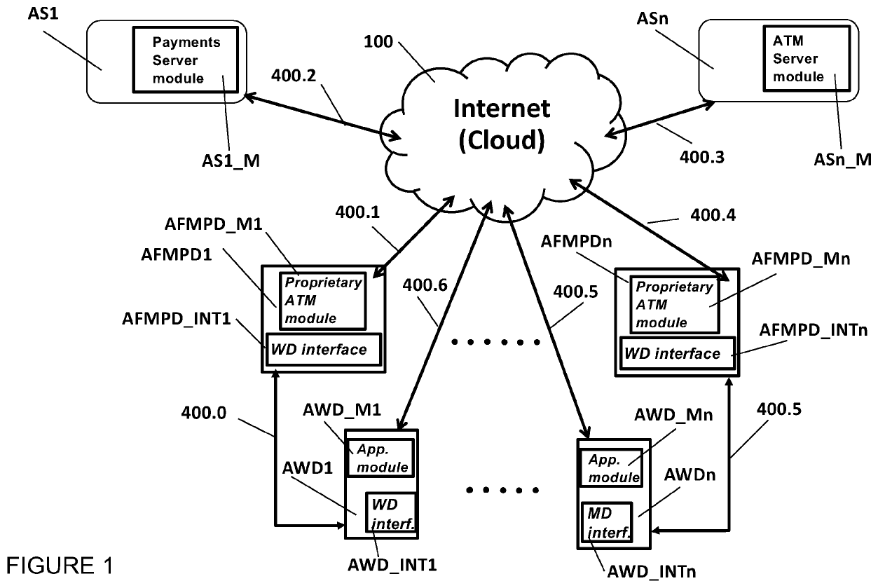

Specifically, FIG. 1 is a typical example of the present invention, applicable amongst others but not limited to an ATM system or a payment processing system.

The system of FIG. 1 comprises at least;

one or more Servers (AS1, ASn) adapted as per an example of this invention to include a “payments server module” (AS1_M) and an ATM transactions processing module (ASn_M), and

one or more ATMs (AFMPD1, AFMPDn) adapted as per an example of this invention to include a “proprietary Mobile interface module” (AFMPD1_INT1, AFMPD_INTn) and a proprietary ATM transactions processing module (AFMPD1, AFMPDn), and

one or more wireless devices (AWD1, AWDn) adapted as per an example of this invention to include a “proprietary Mobile interface module” (AMD1_INT1, AMD_INTn) and a proprietary application module (AWD1, AWDn), wherein

to imitate a transaction by an end-user, for example a user wishing to deposit cash at that adapted ATM, then the user of that adapted wireless device (for example an adapted smartphone AWD1) has to login to his AWD1 smartphone and authenticate through the internet interface (400.6) then through the internet (100) with the system server (AS1), to verify its identity by two factor authentication, or by multi-factor authentication, and/or by biometric identification. Once the server AS1 confirms authentication to the wireless device AWD1, the user can enter through the mobile application (AWD_M1) screen the cash amount he wishes to deposit and receive on his account at AS1 in digital form. The user then clicks on the adapted ATM (AFMPD1) screen on a dedicated home screen key, in example such key potentially called “TT” as in “Trusted Transfer”. The ATM (AFMPD1) then activates the adapted mobile interface (AFMPD_INT1) to process and recognize the proprietary protocol from the adapted wireless devices (AWD1) when nearing the ATM interface AFMPD_INT1.

The user is then prompted on the ATM screen to follow the required steps and is given a timeout to tap his smartphone AWD1 interface AWD_INT1 in close proximity or virtually touching with the ATM interface (AFMPD_INT1). The wireless device (AWD1) then automatically provides the ATM (AFMP1) upon detecting its proprietary communications protocol and provides the ATM with at least the following information: (i) the amount the user wants to deposit, (ii) the currency, (iii) the unique transaction identifier of that specific transaction, (iv) the transaction type, in this case “cash deposit”.

The ATM (AFMPD1) then communicates through an API (application programming interface) 400.1 through the internet 100 directly with the server AS1 through 400.2 or indirectly through 400.3 with server ASn back through the internet 100 through 400.2 to server AS1 to confirm when the exact amount counted is identical to the amount it received from wireless device AWD1. If the amount of cash counted by the ATM (AFMPD1) is different than the amount received from the communication started by ASD1, then the ATM cancels that operation and returns the money to the end-user.

If the amounts are the same, then the server AS1 executes a transfer of that amount and currency from the AFMPD1 escrow account to the AWD1 end-user wallet and confirms on screen the transaction as completed and the AS1 server sends a notification to the AWD1 device through the application module AWD_M1.

In this way the server AS1 receives two independent communications, one from the AWD_M1 and one from the AFMPD_M1 confirming from two independent sources the minimum information of that specific transaction and verifies that at least the amount, currency, transaction type and unique transaction identifier are identical from the two sources before it makes the actual transfer of electronic assets from the ATM owner wallet to the end-user wallet, reducing the potential of financial risks to the owner of the AS1 services as well as the owner of the ATM services, assuming in this example they are two different entities.

In a different example, if the user enters a cash withdrawal transaction type, the process flow and order of actions is the same as the above-described cash deposit type except for the following:
In a cash withdrawal scenario the adapted ATM will interact with the AS1 server to verify that the amount requested by the end-user is available in the user wallet with AS1, wherein AS1, if both communications it received from both the adapted wireless device (AWD1) and from the adapted ATM (AFMPD1) are identical, meaning, same transaction amount, same currency, same transaction type in this case cash withdrawal, same unique transaction identifier, then the server AS1 will first transfer that amount and currency from the AWD1 end-user wallet to the escrow account of the owner of that specific adapted ATM (AFMPD1) and notify that ATM of such transfer executed or of such funds cleared at the ATM owner wallet if such ATM owner has an escrow wallet also at AS1 (this last being a preferred example of the present invention), and the adapted ATM then dispenses that exact amount to the end-user and notifies the user on the ATM screen whilst the user will also receive an application module notification on his adapted wireless device which was sent by the server AS1.

In a different example of the present invention, the AS1 server in the event of the currency between the one received at the initiation of the transaction from the wireless device AWD1 is different than the currency available in the ATM for withdrawal and received by server AS1 from the ATM (AFMPD1), then the server (AS1) will apply a foreign exchange rate which the user accepted previously as part of the terms and conditions of use and in this case the server AS1 allows such transaction(s) to be executed.

In a different example of the present invention, the AS1 server in the event of the currency between the one received at the initiation of the transaction from the wireless device AWD1 is different than the currency available in the ATM for cash deposit and received by server AS1 from the ATM (AFMPD1), provided the cash deposited is in a currency the adapted ATM (AFMPD1) accepts, then the server (AS1) or alternatively server (ASn) will apply a foreign exchange rate which the user accepted previously as part of the terms and conditions of use and in this case the server AS1 allows such transaction(s) to be executed.

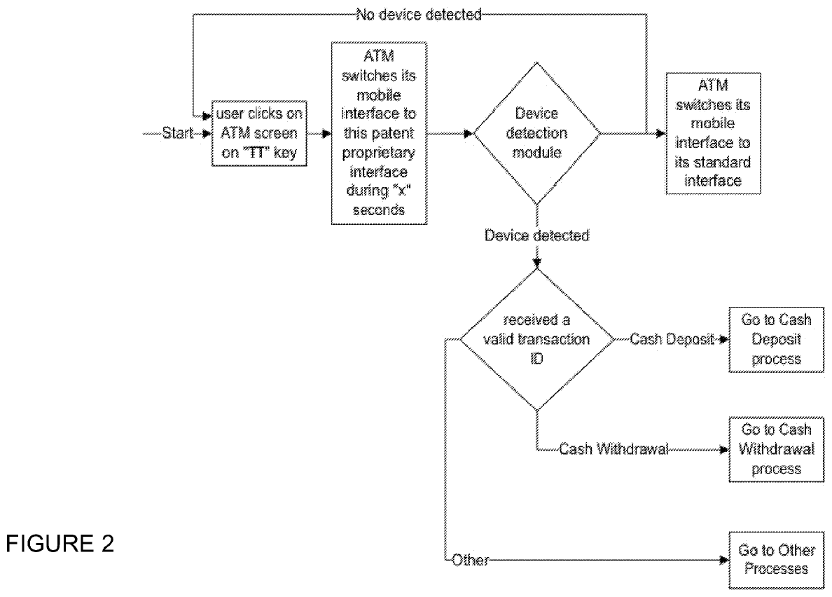

FIG. 2 represents a flow-chart of the communication method, for example between the adapted Wireless Devices (e.g. AWD1 of FIG. 1) and the adapted ATM devices (e.g. AFMPD1 of FIG. 1), wherein the start of the process is when the end-user of device AWD1 clicks on a dedicated key on the adapted ATM (AFMPD1) screen which switches the standard ATM function to the adapted ATM function and activates the device detection function, to detect if the device is an adapted device as per an example of this invention (for example AWD1 to AWDn). If the device detected is not compliant with an example of this invention then the adapted ATM will switch back to standard ATM mode and ends this process. The user is given a timeout to initiate a specific transaction type (example, cash deposit or cash withdrawal, or other) by nearing his adapted wireless device (AWD) in very close proximity of the AATM interface. If, however the device is detected as one being compliant with an example of this invention then the module will extract which transaction type the end-user entered on his device before he tapped it near to the adapted ATM interface. The typical transaction types are: cash deposit, cash withdrawal or another, where another can be paying for or extracting the digital receipt or entrance for a local event, such as a concert, theatre, cinema etc.

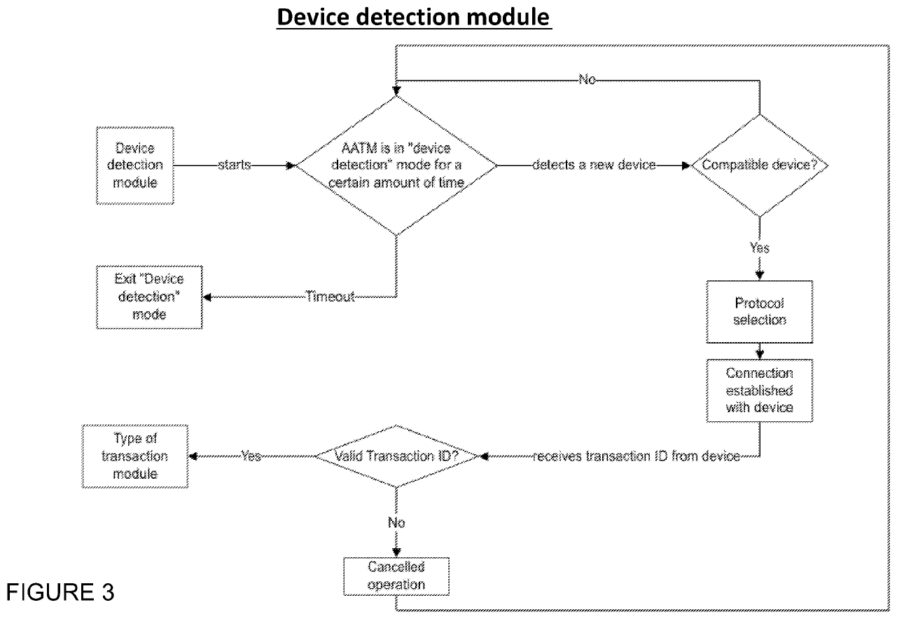

FIG. 3 represents an example of the “device detection module” wherein this module may be triggered by detecting a device which automatically then activates the adapted ATM “device aware mode” and by detecting the proprietary handshake it confirms if it is an adapted device as per an example of this invention. If it confirms that it is a compatible device, then the module selects the compatible protocol between both devices and establishes a connection between them and extracts the payload information, such as for example but not limited to the unique transaction identifier, the amount and currency, and the transaction type. At this point the unique transaction identifier is verified if it is a valid one or an expired one, and if it is valid then the module progresses to the next module that corresponds to the extracted transaction type, for example go to the Cash deposit module if that was extracted.

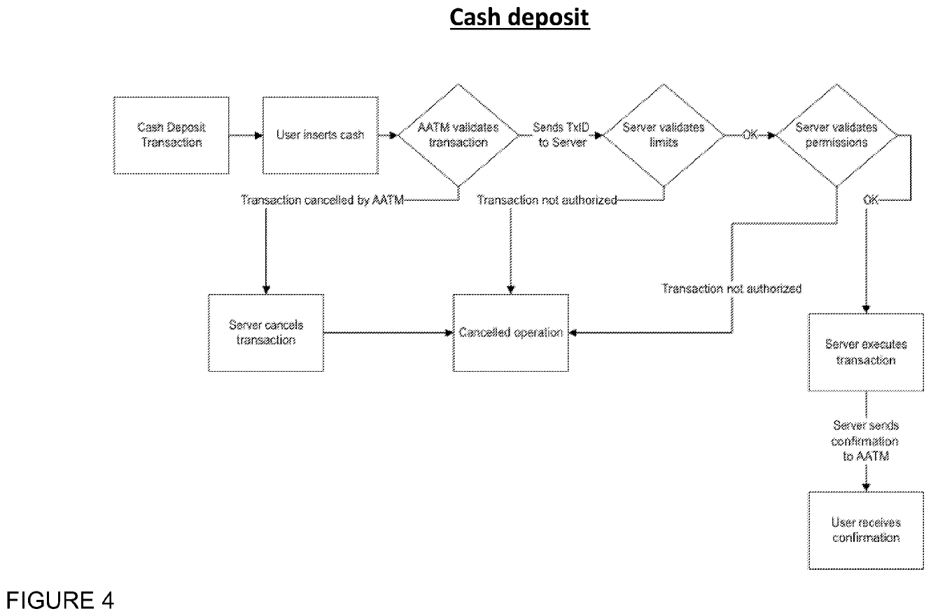

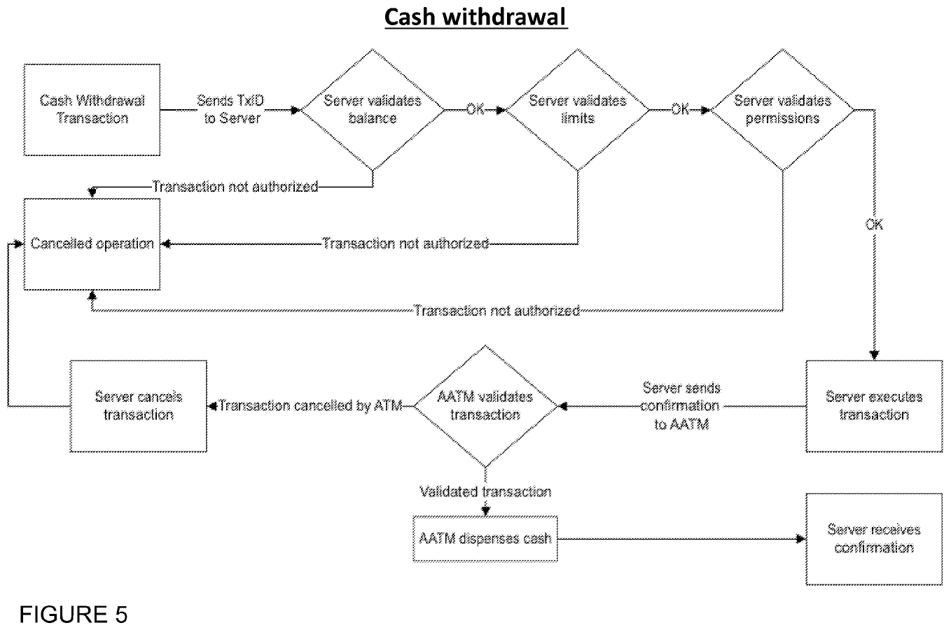

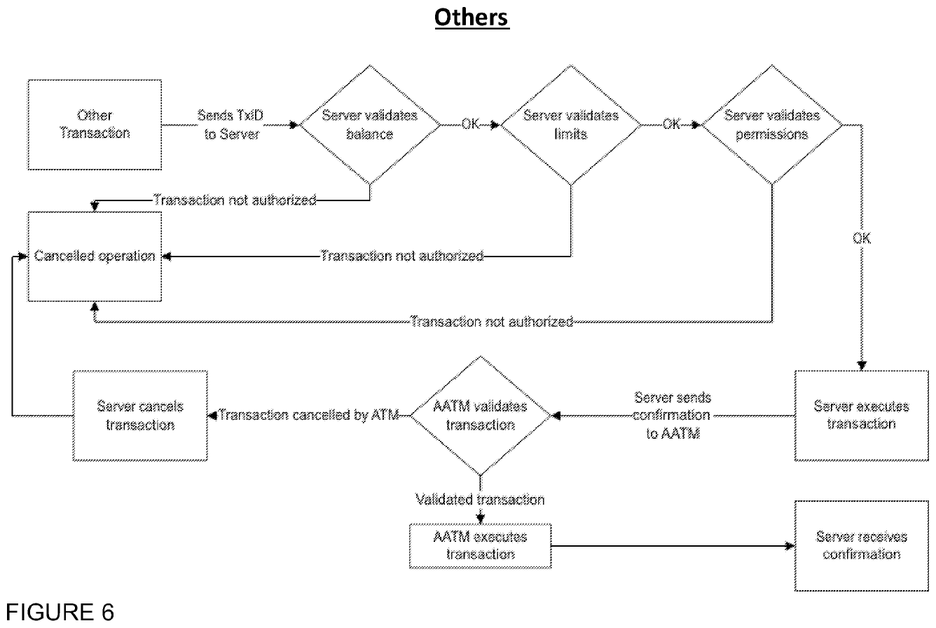

FIGS. 4, 5 and 6 represent examples, respectively of the “cash deposit process”-, the “cash withdrawal”-, and “other transaction type”-module of examples of the present invention, showing a detailed flow of the corresponding module with the corresponding name. Specifically in FIG. 6, typical other transactions for an end-user to buy for example electronic events tickets, like for a concert, theatre or cinema and so forth are charged directly to the account where he authenticated in at the start of an operation.

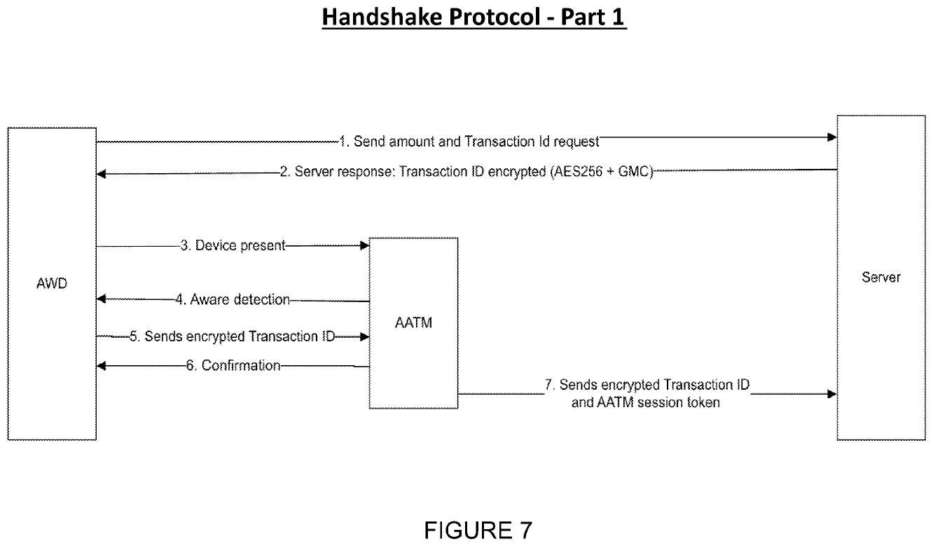

FIG. 7 represents an example of the detailed interfaces communications protocol between the adapted wireless device (AWD1), the adapted ATM device (AFMPD1) and the adapted server device (AS1) as one of the examples of the present invention for the “handshake protocol” between the previous mentioned devices of examples of the present invention.

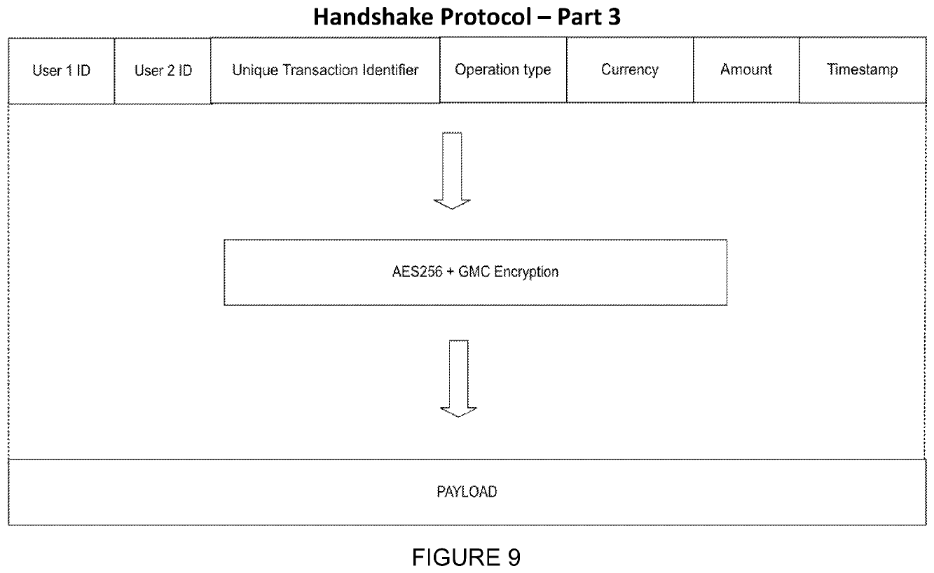

If the transaction cannot be done due to a lack of cash available or lack of space to store cash in the adapted ATM, or connectivity loss (in example loss of internet connection or loss of communication to the adapted system server or any other reason), the same channel used to confirm the operation (e.g. 400.0 of FIG. 1) can be used in a different example of the present invention by the adapted ATM device (AFMPD1) to inform the adapted wireless device (AWD1) that the operation is cancelled, just by sending a dedicated code through the confirmation process (e.g. step 6 in FIG. 7) without the adapted ATM (AFMPD1) needing to connect to the adapted server device (AS1) and cancel that operation or transaction before the expiration time of the unique transaction identifier (see e.g. FIG. 9) would cancel that operation or transaction anyway by the adapted system server (AS1).

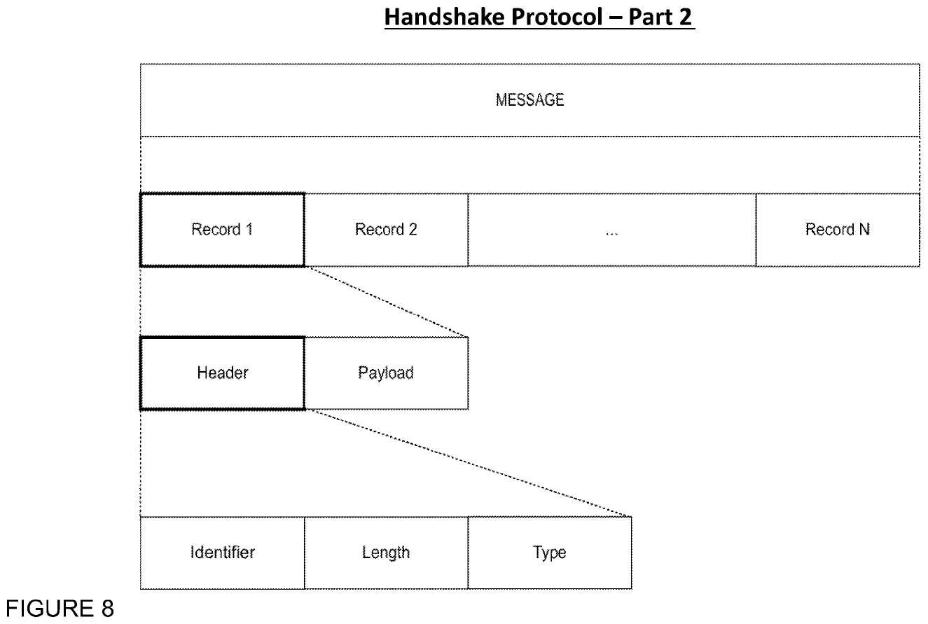

FIG. 8 represents an example of the detailed content of the message content exchanged between the adapted wireless device (AWD1) and the adapted ATM device (AFMPD1) from which the “handshake protocol” started from the processing of the “transaction ID” (unique transaction identifier), respectively showing the content of a given message containing from 1 to n records, wherein each record includes of a header and a payload, and wherein the header includes a code representing the unique identification of the message, a code representing the length of the message, and a code representing the type of the message, wherein the identifier, length and type are standard prior art but the payload is an adapted payload as per an example of this invention and detailed in FIG. 9 for example.

FIG. 9 represents an example of the detailed content of the message payload wherein the main fields are “User 1 ID” and “User 2 ID” representing the adapted wireless device (AWD1) and the adapted ATM (AFMPD1), and wherein the unique transaction identifier (UTID) corresponds to the actual transaction initiated by the WD1 user and typically generated by the system server and provided to the adapted wireless device (AWD1) or generated by the AWD1, and wherein the “operation type” is a unique code as per this invention representing for example a cash deposit, a cash withdrawal or any such other transaction type selected by the user of AWD1, and wherein the “currency” is a unique code as per an example of this invention representing for example a GBP, EUR, USD, MXN, BTC, ETH, or any such other digital asset type or currency selected by the user of AWD1, and wherein the “amount” is a unique code as per an example of this invention representing for example a numerical or a fraction thereof selected by the user of AWD1, and wherein the “time stamp” is a unique code as per an example of this invention representing for example a local time or a given time zone time, selected by the system server AS1 (adapted server device) and inserted in the corresponding message payload portion by the AWD1 (adapted wireless device) and/or the AFMPD1 (adapted ATM device) and/or the system server AS1 (adapted server device). Any known information in any of these fields can be left empty by the AWD1 or the AFMPD1 and filled in automatically by the AS1.

Examples of this invention, including the claims, descriptions and drawings in this document, allows for the development of cheaper and smaller ATMs.

In an example, an ATM is in fact composed by a combination of several devices interconnected between them and controlled by a computer with a dedicated software to form a; cash dispenser, cash collector, card reader, NFC reader, screen, keyboard and printer. The typical problems associated to these devices are vandalism, fraud and weather-related problems. In the prior art, it is common to find an ATM with; liquids having been poured over the keyboard, rubbish thrown over them, screen with scratches, broken screens or bubble gums in the card reader.

The weather can be a big problem, depending on the country where the ATM is installed. It's common to find metal keyboards that are too hot for common use or hard to see screens because of the effect of direct sun in certain countries, especially in summer, or even unusable devices because of the rain or humidity or the degree of vandalism. An ATM can also run out of paper and, in consequence, be unable to give a receipt to the user.

With an example of this invention, a user can make use of a modified ATM as per an example of this invention, by just using the adapted wireless device interfacing with the adapted ATM, making some devices that used to make up the prior art ATM unnecessary, such as the keyboard, and/or screen, and/or card strip reader or printer, as in an example all the interface process and the communication between the system server and user can be done through the adapted wireless device as per an example of this invention.

This opens the possibility of creating much smaller size and cheaper ATMs, as less devices are needed to make up an adapted ATM as per an example of this invention, consequently increasing the up-time when an ATM is operational and not down, by reducing the number of technical issues simply because there are less devices inside the adapted ATM. Also, an example of this invention makes the statistical probability to commit fraud much less likely simply because removing the need to have all those devices that made up the prior art ATM, thus making the actual adapted ATM transactions interacting through an adapted wireless device or smartphone much safer. By reducing the physical size of the ATM, it is possible to create multiple ATM interfaces with a common vaulted cash handler behind, reducing the production and installation costs and having the added benefit of possibly having say two or more end-user interfaces connected to one adapted ATM interacting with the adapted wireless devices, wherein the adapted ATM with multiple wireless device interfaces would fit in the current space of the prior art ATM space thus increasing the capacity.

Examples of this invention makes the end-to-end process of ATM transactions safer, as, in fact, an example of this invention requires a user authenticate his and check his identity through an adapted wireless device and a unique transaction identifier per transaction, this last being confirmed separately by the adapted wireless device and by the adapted ATM to the adapted system server to process any given transaction, making fraud statistically so low compared to prior art physical cards or virtual cards in smartphones simply by the fact of breaking the actual transaction in two parts, one by the adapted smartphone to the adapted server and another by the adapted ATM to the same adapted server wherein the adapted server would only execute the transaction if both transaction parts confirm exactly the same information for the same unique transaction identifier as described in this document.

One of the most important problems associated to ATMs are cloned cards. As the card is easily readable and can't process transactions or verify user identities by itself, moreover the prior art and the high amount of card fraud levels confirm the fact that a card is easily cloneable. Many cards are cloned yearly and used or sold on consequently by fraudsters or hackers.

However, an example of this invention introduces additional safety measure that makes this process less vulnerable to fraudsters or hackers unlike the cards, as even if the wireless device is stolen it still makes thieves unable to operate the adapted wireless device with an adapted ATM.

To start any transaction with the innovations in examples of this invention, the user must login into the adapted wireless device and authenticate the user identity through the software module (App) in the adapted device (AWD1) with the adapted system server (AS1), meaning using not only the user/pass combination, but also a Two-factor authentication (2FA) system or a Multi-factor authentication (MFA) system that can be biometrical and/or an adapted face recognition through (AWD1) where the adapted system server (AS1) verifies if it is the same person as the KYC documents that it has access to. This measure warranties that only authorized and authenticated users as in the person who has been identified before the adapted wireless device (AWD1) can start a communication session with the adapted ATM (AFMPD1).

Once authenticated then the user of AWD1 is allowed to configure the desired AFMPD1 operation, but still from the AWD1 device, which lets the user select or enter the amount, currency and operation type and any such other desired parameters without being exposed and only interacts with the adapted ATM over a very short time frame, thus reducing the time exposure to hackers and fraudsters.

This process reduces the time needed to conclude any given operation with the adapted ATM, which increases the available time of the adapted ATM to perform new transactions, and make the process safer for users, as they need less exposure time in an operation.

Examples of this invention eliminate the necessity of printing cards, replacing them, and avoids lost and stolen cards, as the only point where you need a physical card today to operate is actually on an ATM for cash deposits or cash withdrawals.

Many modifications and variations or different examples of this present invention are possible in view of the disclosures herein re this document's text, figures, drawings and explanations. It is to be understood that, within the scope of the appended claims, the invention can be practiced other than as specifically described in the claims or text of this invention. This invention which is intended to be protected should not, however, be construed as limited to the particular forms disclosed, or implementation examples outlined, as these are to be regarded as illustrative rather than restrictive. Variations and changes could be made by those skilled in the art without deviating from the novelty of the invention. Accordingly, the detailed descriptions and figures of this invention should be considered exemplary in nature and not limited to the novelties of the invention as set forth in the claims.

### CONCEPTS

1. A payments system, comprising at least one or more wireless device (AWD1), at least one or more automated teller machine or ATM device (AFMPD1) and at least one or more system server (AS1 and ASn combined as one server or as two individual independent servers), and wherein;
   a) the wireless device (AWD1) the ATM device (AFMPD1) and the server device (AS1) are all internet enabled devices, and wherein;
   b) the ATM device (AFMPD1) has an end-user interface, including at least one built-in transceiver, wherein that ATM transceiver is adapted to download or embed a respective software module (AFMPD_M1) and a wireless device interface module (AFMPD_INT1); wherein the ATM device (AFMPD1) is automatically upon download of the software module (AFMPD_M1) configured to make the software module (AFMPD_M1) through interface (AFMPD_INT1) operable to communicate with the wireless device module (AWD_M1) through wireless device interface (AWD_INT1),
   c) the wireless device (AWD1) has an end-user interface, including at least one built-in transceiver, wherein that wireless device transceiver is adapted to download a respective software module (AWD_M1) and a wireless device interface module (AWD_INT1); wherein the wireless device (AWD1) is automatically upon download of the software module (AWD_M1) configured to make the software module (AWD_M1) through interface (AWD_INT1) operable to communicate with the ATM software module (AFMPD_M1) through wireless device interface (AFMPD_INT1).
   d) the server device (AS1 and ASn) has no direct end-user interface, wherein the server device is adapted to download or embed a respective software module (AS1_M and ASn_M); wherein the server device (AS1 and ASn) is automatically upon download of the software module (AS1_M and ASn_M) configured to make the software module (AS1_M and ASn_M) operable to communicate with the ATM software module (AFMPD_M1) and with the wireless device module (AWD_M1) through the internet (100).
   e) each ATM device (AFMPD1) with a downloaded software module (AFMPD_M1) with direct Internet connection (400.1) is configured to permanently scan through all its available local transceivers for the nearby wireless device (AWD1), wherein AWD1 with a downloaded software module (AWD_M1) has a direct Internet connection, wherein the transceivers of the ATM device (AWD1) is used only in receive mode, until the wireless device (AWD1) with a downloaded software module (AWD_M1) with direct Internet connection requests a communication with the ATM module (AFMPD_M1), and then automatically a bidirectional Send/Receive mode of the ATM device (AFMPD1) and the wireless device (AWD1) is turned on; and
   f) wherein; upon the wireless device software module (AWD_M1) receiving the inputs from the end-user through the wireless device user interface is configured to automatically request a unique transaction identifier (UTID) from the server software module (AS1_M) for that transaction with a validity timeout for that UTID, and sends the user inputted data corresponding with that unique transaction identifier, namely the transaction type, transaction amount and transaction currency to the server software module (AS1_M), and upon the wireless device software module (AWD_M1) detecting a communication with the ATM device software module (AFMPD_M1), then the wireless device software module (AWD_M1) is enabled to automatically send to the ATM device software module (AFMPD_M1) a message containing at least the unique transaction identifier of that transaction, the transaction type (cash deposit, cash withdrawal other), transaction amount, transaction currency, optional a time stamp and
   g) wherein if the wireless device (AWD1) is detected by the ATM device (AFMPD1) as an authorised wireless device (AWD1) with a downloaded software module (AWD_M1), then the ATM device software module (AFMPD_M1) of the ATM device (AFMPD1) is configured to auto decrypt and extract from the communication message with the wireless device (AWD1) the unique transaction identifier (UTID), transaction type, transaction amount and transaction currency, and
   h) wherein, the ATM device software module (AFMPD1) is enabled to automatically upon receipt of a UTID to request to the server software module (AS1_M) if it is a valid UTID, where in the event of an expired UTID then the transaction is cancelled and, in the event if the UTID is valid then the ATM device software module (AFMPD_M1) sends the extracted information to the server software module (AS1_M), namely at least the unique transaction identifier (UTID), transaction type, transaction amount and transaction currency, optional a time stamp and
   i) wherein upon the server device module (AS1_M) receiving the last of the two separate asynchronous confirmation communications from the wireless device software module (AWD_M1) and the ATM device software module (AFMPD_M1) corresponding to the exact same UTID, with the same transaction type, transaction amount and same transaction currency, optional the time stamps, then the ATM device software module (AFMPD_M1) is enabled to automatically execute the transaction, and
   j) wherein the server (AS1) software module (AFMPD_M1) notifies both the ATM device software module (AFMPD1_M1) and the wireless device (AWD1) software module (AWD_M1) of the transaction type and amount and currency having been already executed, and
   k) wherein the ATM device (AFMPD1) then executes the corresponding transaction type, in the event of a cash deposit it then stores that cash in the ATM device (AFMPD1), and in the event of a cash withdrawal it then dispenses that cash amount in the ATM device (AFMPD1) cash dispenser for the end-user of the wireless device (AWD1) to take it, and in the event the money is not picked up by the end-user within a timeout or the ATM device (AFMPD1) is jammed and cannot dispense the cash then the ATM device software module (AFMPD_M1) notifies the server software module (AS1_M) and reverses the transaction and the server module (AS1_M) then notifies of the transaction canceled to both the ATM software module (AFMPD_M1) and the wireless device software module (AWD_M1), this last triggers a notification to the end-user through the user interface of the wireless device (AWD1).
2. A payments system of Concept 1, in which the wireless device is a mobile phone, smartphone, wherein the wireless device has a transceiver enabled to connect to the internet and a different independent transceiver enabled to connect to the ATM device of Concept 1.
3. A payments system of Concept 1, in which the ATM device is a fixed device with a built-in computer enabled to connect to the internet, wherein the ATM device has a transceiver enabled to connect to the wireless device of Concept 1.
4. A payments system of Concept 1, in which the ATM device is a fixed device with a built-in computer enabled to connect to the internet, wherein the ATM device does not have any screen but has a keyboard.
5. A payments system of Concept 1, in which the ATM has more than one transceiver enabled to connect to different independent wireless device of Concept 1.
6. A payments system of Concept 1, in which the system server (AS1) transaction execution in the event of;
   a cash deposit transaction type, the server makes a transfer of the amount and currency from the ATM device AFMPD1 owner to the wallet of wireless device AWD1 owner,
   a cash withdrawal transaction type, the server makes a transfer of the amount and currency from the wireless device AWD1 owner to the wallet of the ATM device (AFMPD1) owner,
   other is a transfer from the wallet of the paying party to the wallet of the receiving party.
7. A payments system of Concept 1, in which the transaction amount can be in any asset class, be it traditional currency (EUR, GBP, USD, MXN, BRL, etc), crypto currency (BTC, ETH, ADA, BNB, USDT, etc), shares, tokens, exchange traded fund units, equity, bonds, loyalty points.
8. A payments system of Concept 1, in which the communication interfaces (AWD_INT1) of wireless device (AWD1) and interface (AFMPD_INT1) of ATM device (AFMPD1) are based on bidirectional near field communications (NFC), bidirectional non-audible frequency band communications, bidirectional non-visible light band communications.
9. A payments system, comprising at least one or more wireless device (AWD1), at least one or more automated teller machine device (AFMPD1) and at least one or more system server (AS1), such automated teller machine having no screen and no keyboard but has a wireless device interface and wherein;
   b) the wireless device (AWD1) the ATM device (AFMPD1) and the server device (AS1) are all internet enabled devices, and wherein;
   b) the ATM device (AFMPD1) has no end-user interface, but including at least two or more built-in transceiver to connect to the internet and another transceiver to connect to the wireless device module (AWD_M1), wherein one of the ATM transceiver is adapted to download a software module (AFMPD_M1) and a wireless device interface module (AFMPD_INT1); wherein the ATM device (AFMPD1) is automatically upon download of the software module (AFMPD_M1) configured to make the software module (AFMPD_M1) through interface (AFMPD_INT1) operable to communicate with the wireless device module (AWD_M1) through wireless device interface (AWD_INT1),
   c) the wireless device (AWD1) has an end-user interface, including at least two or more built-in transceivers to connect to the internet and another transceiver to connect to the ATM device (AFMPD1), wherein one of the wireless device transceivers is adapted to download a respective software module (AWD_M1) and a wireless device interface module (AWD_INT1); wherein the wireless device (AWD1) is automatically upon download of the software module (AWD_M1) configured to make the software module (AWD_M1) through interface (AWD_INT1) operable to communicate with the ATM software module (AFMPD_M1) through wireless device interface (AFMPD_INT1).
   d) the server device (AS1 and ASn) has no direct end-user interface, wherein the server device is adapted to download or embed a respective software module (AS1_M and ASn_M); wherein the server device (AS1 and ASn) is automatically upon download of the software module (AS1_M and ASn_M) configured to make the software module (AS1_M and ASn_M) operable to communicate with the ATM software module (AFMPD_M1) and with the wireless device module (AWD_M1) through the internet (100).
   e) each ATM device (AFMPD1) with a downloaded software module (AFMPD_M1) with direct Internet connection is configured to permanently scan through all its available local transceivers for the nearby wireless device (AWD1), wherein AWD1 with a downloaded software module (AWD_M1) has a direct Internet connection, wherein the transceivers of the ATM device (AWD1) is used only in receive mode, until the wireless device (AWD1) with a downloaded software module (AWD_M1) with direct Internet connection requests a communication with the ATM module (AFMPD_M1), and then automatically a bidirectional Send/Receive mode of the ATM device (AFMPD1) and the wireless device (AWD1) is turned on; and
   f) wherein; upon the wireless device software module (AWD_M1) receiving the inputs from the end-user through the wireless device user interface, the wireless device is configured to automatically requests a unique transaction identifier (UTID) from the server software module (AS1_M) for that transaction with a validity timeout for that UTID, and send the user inputted data corresponding with that unique transaction identifier, namely the transaction type, transaction amount and transaction currency to the server software module (AS1_M), and upon the wireless device software module (AWD_M1) detecting a communication with the ATM device software module (AFMPD_M1), then the wireless device software module (AWD_M1) is enabled to automatically send to the ATM device software module (AFMPD_M1) a message containing at least the unique transaction identifier of that transaction, the transaction type (cash deposit, cash withdrawal other), transaction amount, transaction currency, optional a time stamp and
   g) wherein if the wireless device (AWD1) is detected by the ATM device (AFMPD1) as an authorised wireless device (AWD1) with a downloaded software module (AWD_M1), then the ATM device software module (AFMPD_M1) of the ATM device (AFMPD1) is configured to auto decrypt and extract from the communication message with the wireless device (AWD1) the unique transaction identifier (UTID), transaction type, transaction amount and transaction currency, and
   h) wherein, the ATM device software module (AFMPD1) is enabled to automatically upon receipt of a UTID to request to the server software module (AS1_M) if it is a valid UTID, wherein in the event of an expired UTID then the transaction is cancelled and, in the event if the UTID is valid then the ATM device software module (AFMPD_M1) sends the extracted information to the server software module (AS1_M), namely at least the unique transaction identifier (UTID), transaction type, transaction amount and transaction currency, optional a time stamp and
   i) wherein upon the server device module (AS1_M) receiving the last of the two separate asynchronous confirmation communications from the wireless device software module (AWD_M1) and the ATM device software module (AFMPD_M1) corresponding to the exact same UTID, with the same transaction type, transaction amount and same transaction currency, optional the time stamps, then the ATM device software module (AFMPD_M1) is enabled to automatically execute the transaction, and
   j) wherein the server (AS1) software module (AFMPD_M1) notifies both the ATM device software module (AFMPD1_M1) and the wireless device (AWD1) software module (AWD_M1) of the transaction type and amount and currency having been already executed, and
   k) wherein the ATM device (AFMPD1) then executes the corresponding transaction type, and in the event of a cash deposit it then stores that cash in the ATM device (AFMPD1), and in the event of a cash withdrawal it then dispenses that cash amount in the ATM device (AFMPD1) cash dispenser for the end-user of the wireless device (AWD1) to take it, and in the event the money is not picked up by the end-user within a timeout or the ATM device (AFMPD1) is jammed and cannot dispense the cash then the ATM device software module (AFMPD_M1) notifies the server software module (AS1_M) and reverses the transaction and the server module (AS1_M) then notifies of the transaction canceled to both the ATM software module (AFMPD_M1) and the wireless device software module (AWD_M1), this last triggers a notification to the end-user through the user interface of the wireless device (AWD1).
10. A payments system of Concept 9, wherein Concepts 2 to 8 each individually or jointly are dependent Concepts of Concept 9 instead of Concept 1.

### NOTE

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A payments system, comprising: a wireless computing device (AWD1); an automated teller computing machine device (AFMPD1) and a system server (AS1), the automated teller computing machine device including a respective wireless device interface module (AFMPD_INT1), the automated teller computing machine device not including an end-user screen interface, the automated teller computing machine device not including an end-user keypad interface, wherein:
a) the wireless computing device (AWD1), the automated teller computing machine device (AFMPD1) and the server device (AS1) are all internet enabled devices, and the wireless computing device (AWD1) includes a wireless computing device module (AWD_M1) and a wireless computing device interface (AWD_INT1);
b) the ATM device (AFMPD1) includes at least two built-in transceivers, respectively configured to connect to the internet and to connect to the wireless computing device module (AWD_M1), wherein one of the ATM transceivers is adapted to download a software module (AFMPD_M1) and a wireless device interface module (AFMPD_INT1); wherein the ATM device (AFMPD1) is automatically upon download of the software module (AFMPD_M1) configured to make the software module (AFMPD_M1) via the wireless device interface module (AFMPD_INT1) operable to communicate with the wireless computing device module (AWD_M1) through the wireless computing device interface (AWD_INT1);
c) the wireless computing device (AWD1) includes an end-user interface, and includes at least two built-in transceivers respectively configured to connect to the internet and to connect to the ATM device (AFMPD1), wherein one of the wireless computing device transceivers is adapted to download a respective software module (AWD_M1) and a wireless computing device interface module (AWD_INT1); wherein the wireless computing device (AWD1) is automatically upon download of the software module (AWD_M1) configured to make the software module (AWD_M1) through the wireless computing device interface module (AWD_INT1) operable to communicate with the ATM software module (AFMPD_M1) through the wireless device interface (AFMPD_INT1);
d) the server device (AS1, ASn) includes no direct end-user interface, wherein the server device is adapted to download or embed a respective software module (AS1_M, ASn_M); wherein the server device (AS1, ASn) is automatically upon download or embedding of the software module (AS1_M, ASn_M) configured to make the software module (AS1_M, ASn_M) operable to communicate with the ATM software module (AFMPD_M1) and with the wireless computing device module (AWD_M1), through the internet (100);
e) the ATM device (AFMPD1) including the downloaded software module (AFMPD_M1) is configured to scan through one, some or all of its available local transceivers for a communication from the wireless computing device (AWD1), wherein the wireless computing device (AWD1) with a downloaded software module (AWD_M1) is directly connectable to the Internet, wherein the transceivers of the ATM device (AFMPD1) are used only in receive mode, until the wireless computing device (AWD1) with a downloaded software module (AWD_M1) requests a communication with the ATM software module (AFMPD_M1), and then automatically in response a bidirectional Send/Receive mode of the ATM device (AFMPD1) and the wireless computing device (AWD1) is turned on; and
f) wherein the wireless computing device software module (AWD_M1), in response to receiving input from an end-user through the wireless computing device user interface, is configured to automatically request a unique transaction identifier (UTID) from the server software module (AS1_M) for a transaction with a validity timeout for that UTID, and to send user inputted data corresponding with that unique transaction identifier, including a transaction type, a transaction amount and a transaction currency, to the server software module (AS1_M), and the wireless computing device software module (AWD_M1) is configured to detect a communication from the ATM device software module (AFMPD_M1), in response to which the wireless computing device software module (AWD_M1) is configured to automatically send to the ATM device software module (AFMPD_M1) a message including at least the unique transaction identifier of that transaction, the transaction type (e.g. cash deposit, cash withdrawal, other), the transaction amount, the transaction currency, and optionally a time stamp; and
g) the ATM device (AFMPD1) is configured to determine if the wireless computing device (AWD1) is an authorized wireless computing device (AWD1) with a downloaded software module (AWD_M1), and if the ATM device (AFMPD1) determines the wireless computing device (AWD1) is an authorized wireless computing device (AWD1) with a downloaded software module (AWD_M1), then the ATM device software module (AFMPD_M1) of the ATM device (AFMPD1) is configured to auto decrypt and extract from a communication message with the wireless computing device (AWD1) the unique transaction identifier (UTID), the transaction type, the transaction amount and the transaction currency, and
h) wherein the ATM device software module (AFMPD1) is configured such that automatically upon receipt of a UTID from the wireless computing device software module (AWD_M1), the ATM device software module (AFMPD1) requests to the server software module (AS1_M) if the UTID is a valid UTID, wherein in the event of an expired UTID then the transaction is cancelled and, in the event the UTID is valid then the ATM device software module (AFMPD_M1) sends the extracted information to the server software module (AS1_M), including at least the unique transaction identifier (UTID), the transaction type, the transaction amount and the transaction currency, and optionally a time stamp and
i) wherein upon the server device module (AS1_M) receiving the last of the two separate asynchronous confirmation communications from the wireless computing device software module (AWD_M1) and the ATM device software module (AFMPD_M1), corresponding to the exact same UTID, with the same transaction type, the same transaction amount and the same transaction currency, and optionally the time stamps, then the ATM device software module (AFMPD_M1) is authorized to automatically execute the transaction, and
j) wherein the server (AS1) software module (AFMPD_M1) is configured to notify both the ATM device software module (AFMPD1_M1) and the wireless computing device (AWD1) software module (AWD_M1) of the transaction type and amount and currency having been executed, and
k) wherein the ATM device (AFMPD1) then executes the corresponding transaction type, wherein in the event of a cash deposit the ATM device (AFMPD1) then stores that cash in the ATM device (AFMPD1), and wherein in the event of a cash withdrawal the ATM device (AFMPD1) then dispenses that cash amount in a cash dispenser of the ATM device (AFMPD1) for the end-user of the wireless computing device (AWD1) to collect.

2. The system of claim 1, wherein in the event the money is not picked up by the end-user within a timeout or the ATM device (AFMPD1) is jammed and cannot dispense the cash then the ATM device software module (AFMPD_M1) notifies the server software module (AS1_M) and reverses the transaction and the server module (AS1_M) then notifies that the transaction is canceled to both the ATM software module (AFMPD_M1) and the wireless computing device software module (AWD_M1), and this last event triggers a notification to the end-user through the user interface of the wireless computing device (AWD1).

3. The system of claim 1, wherein the automated teller computing machine device does not include a magnetic card reader.

4. The system of claim 1, in which the wireless computing device is a mobile phone or a smartphone, wherein the wireless computing device has a transceiver enabled to connect to the internet and a different independent transceiver enabled to connect to the ATM device.

5. The system of claim 1, in which the ATM device is a fixed device with a built-in computer enabled to connect to the internet, wherein the ATM device has a transceiver enabled to connect to the wireless computing device.

6. The system of claim 1, in which the ATM device is a fixed device with a built-in computer enabled to connect to the internet.

7. The system of claim 1, in which the ATM device has more than one transceiver enabled to connect to the wireless computing device.

8. The system of claim 1 in which:
in the event of a cash deposit transaction type, the server makes a transfer of the amount and currency from the ATM device (AFMPD1) owner to a wallet of wireless computing device AWD1 owner,
in the event of a cash withdrawal transaction type, the server makes a transfer of the amount and currency from the wireless computing device (AWD1) owner to a wallet of the ATM device (AFMPD1) owner,
in the event of another transaction type, this is a transfer from a wallet of the paying party to a wallet of the receiving party.

9. The system of claim 1, in which the transaction amount can be in any asset class, be it traditional currency (EUR, GBP, USD, MXN, BRL, etc), crypto currency (BTC, ETH, ADA, BNB, USDT, etc), shares, tokens, exchange traded fund units, equity, bonds, loyalty points.

10. The system of claim 1, in which the communication interfaces (AWD_INT1) of wireless computing device (AWD1) and interface (AFMPD_INT1) of ATM device (AFMPD1) are arranged to use one or more of: bidirectional near field communications (NFC), bidirectional non-audible frequency band communications, bidirectional non-visible light band communications.

11. The system of claim 1, in which the automated teller computing machine device includes no end-user interface.

12. A payments system, comprising: a wireless computing device (AWD1); an automated teller computing machine device (AFMPD1) and a system server (AS1), the automated teller computing machine device including a respective wireless device interface module (AFMPD_INT1), the automated teller computing machine device including an end-user interface, wherein:
a) the wireless computing device (AWD1), the automated teller computing machine device (AFMPD1) and the server device (AS1) are all internet enabled devices, and the wireless computing device (AWD1) includes a wireless computing device module (AWD_M1) and a wireless computing device interface (AWD_INT1);
b) the ATM device (AFMPD1) includes at least two built-in transceivers, respectively configured to connect to the internet and to connect to the wireless computing device module (AWD_M1), wherein one of the ATM transceivers is adapted to download a software module (AFMPD_M1) and a wireless device interface module (AFMPD_INT1); wherein the ATM device (AFMPD1) is automatically upon download of the software module (AFMPD_M1) configured to make the software module (AFMPD_M1) via the wireless device interface module (AFMPD_INT1) operable to communicate with the wireless computing device module (AWD_M1) through the wireless computing device interface (AWD_INT1);
c) the wireless computing device (AWD1) includes an end-user interface, and includes at least two built-in transceivers respectively configured to connect to the internet and to connect to the ATM device (AFMPD1), wherein one of the wireless computing device transceivers is adapted to download a respective software module (AWD_M1) and a wireless computing device interface module (AWD_INT1); wherein the wireless computing device (AWD1) is automatically upon download of the software module (AWD_M1) configured to make the software module (AWD_M1) through the wireless computing device interface module (AWD_INT1) operable to communicate with the ATM software module (AFMPD_M1) through the wireless device interface (AFMPD_INT1);
d) the server device (AS1, ASn) includes no direct end-user interface, wherein the server device is adapted to download or embed a respective software module (AS1_M, ASn_M); wherein the server device (AS1, ASn) is automatically upon download or embedding of the software module (AS1_M, ASn_M) configured to make the software module (AS1_M, ASn_M) operable to communicate with the ATM software module (AFMPD_M1) and with the wireless computing device module (AWD_M1), through the internet (100);
e) the ATM device (AFMPD1) including the downloaded software module (AFMPD_M1) is configured to scan through one, some or all of its available local transceivers for a communication from the wireless computing device (AWD1), wherein the wireless computing device (AWD1) with a downloaded software module (AWD_M1) is directly connectable to the Internet, wherein the transceivers of the ATM device (AFMPD1) are used only in receive mode, until the wireless computing device (AWD1) with a downloaded software module (AWD_M1) requests a communication with the ATM software module (AFMPD_M1), and then automatically in response a bidirectional Send/Receive mode of the ATM device (AFMPD1) and the wireless computing device (AWD1) is turned on; and
f) wherein the wireless computing device software module (AWD_M1), in response to receiving input from an end-user through the wireless computing device user interface, is configured to automatically request a unique transaction identifier (UTID) from the server software module (AS1_M) for a transaction with a validity timeout for that UTID, and to send user inputted data corresponding with that unique transaction identifier, including a transaction type, a transaction amount and a transaction currency, to the server software module (AS1_M), and the wireless computing device software module (AWD_M1) is configured to detect a communication from the ATM device software module (AFMPD_M1), in response to which the wireless computing device software module (AWD_M1) is configured to automatically send to the ATM device software module (AFMPD_M1) a message including at least the unique transaction identifier of that transaction, the transaction type (e.g. cash deposit, cash withdrawal, other), the transaction amount, the transaction currency, and optionally a time stamp; and
g) the ATM device (AFMPD1) is configured to determine if the wireless computing device (AWD1) is an authorized wireless computing device (AWD1) with a downloaded software module (AWD_M1), and if the ATM device (AFMPD1) determines the wireless computing device (AWD1) is an authorized wireless computing device (AWD1) with a downloaded software module (AWD_M1), then the ATM device software module (AFMPD_M1) of the ATM device (AFMPD1) is configured to auto decrypt and extract from a communication message with the wireless computing device (AWD1) the unique transaction identifier (UTID), the transaction type, the transaction amount and the transaction currency, and
h) wherein the ATM device software module (AFMPD1) is configured such that automatically upon receipt of a UTID from the wireless computing device software module (AWD_M1), the ATM device software module (AFMPD1) requests to the server software module (AS1_M) if the UTID is a valid UTID, wherein in the event of an expired UTID then the transaction is cancelled and, in the event the UTID is valid then the ATM device software module (AFMPD_M1) sends the extracted information to the server software module (AS1_M), including at least the unique transaction identifier (UTID), the transaction type, the transaction amount and the transaction currency, and optionally a time stamp and
i) wherein upon the server device module (AS1_M) receiving the last of the two separate asynchronous confirmation communications from the wireless computing device software module (AWD_M1) and the ATM device software module (AFMPD_M1), corresponding to the exact same UTID, with the same transaction type, the same transaction amount and the same transaction currency, and optionally the time stamps, then the ATM device software module (AFMPD_M1) is authorized to automatically execute the transaction, and
j) wherein the server (AS1) software module (AFMPD_M1) is configured to notify both the ATM device software module (AFMPD1_M1) and the wireless computing device (AWD1) software module (AWD_M1) of the transaction type and amount and currency having been executed, and
k) wherein the ATM device (AFMPD1) then executes the corresponding transaction type, wherein in the event of a cash deposit the ATM device (AFMPD1) then stores that cash in the ATM device (AFMPD1), and wherein in the event of a cash withdrawal the ATM device (AFMPD1) then dispenses that cash amount in a cash dispenser of the ATM device (AFMPD1) for the end-user of the wireless computing device (AWD1) to collect.

13. The system of claim 12, wherein in the event the money is not picked up by the end-user within a timeout or the ATM device (AFMPD1) is jammed and cannot dispense the cash then the ATM device software module (AFMPD_M1) notifies the server software module (AS1_M) and reverses the transaction and the server module (AS1_M) then notifies that the transaction is canceled to both the ATM software module (AFMPD_M1) and the wireless computing device software module (AWD_M1), and this last event triggers a notification to the end-user through the user interface of the wireless computing device (AWD1).

14. The system of claim 12, wherein the automated teller computing machine device does not include a magnetic card reader.

15. The system of claim 12, in which the wireless computing device is a mobile phone or a smartphone, wherein the wireless computing device has a transceiver enabled to connect to the internet and a different independent transceiver enabled to connect to the ATM device.

16. The system of claim 12, in which the ATM device is a fixed device with a built-in computer enabled to connect to the internet, wherein the ATM device has a transceiver enabled to connect to the wireless computing device.

17. The system of claim 12, in which the ATM device is a fixed device with a built-in computer enabled to connect to the internet.

18. The system of claim 12, in which the ATM device has more than one transceiver enabled to connect to the wireless computing device.

19. The system of claim 12, in which:
in the event of a cash deposit transaction type, the server makes a transfer of the amount and currency from the ATM device (AFMPD1) owner to a wallet of wireless computing device AWD1 owner,
in the event of a cash withdrawal transaction type, the server makes a transfer of the amount and currency from the wireless computing device (AWD1) owner to a wallet of the ATM device (AFMPD1) owner,
in the event of another transaction type, this is a transfer from a wallet of the paying party to a wallet of the receiving party.

20. The system of claim 12, in which the transaction amount can be in any asset class, be it traditional currency (EUR, GBP, USD, MXN, BRL, etc), crypto currency (BTC, ETH, ADA, BNB, USDT, etc), shares, tokens, exchange traded fund units, equity, bonds, loyalty points.

21. The system of claim 12, in which the communication interfaces (AWD_INT1) of wireless computing device (AWD1) and interface (AFMPD_INT1) of ATM device (AFMPD1) are arranged to use one or more of: bidirectional near field communications (NFC), bidirectional non-audible frequency band communications, bidirectional non-visible light band communications.

22. A computer-implemented method of executing a fraud-resistant transaction type, the method using a payments system, comprising: a wireless computing device (AWD1); an automated teller computing machine device (AFMPD1) and a system server (AS1), the automated teller computing machine device including a respective wireless device interface module (AFMPD_INT1), the automated teller computing machine device not including an end-user screen interface, the automated teller computing machine device not including an end-user keypad interface;
wherein the wireless computing device (AWD1), the automated teller computing machine device (AFMPD1) and the server device (AS1) are all internet enabled devices, and the wireless computing device (AWD1) includes a wireless computing device module (AWD_M1) and a wireless computing device interface (AWD_INT1);
wherein the ATM device (AFMPD1) includes at least two built-in transceivers, respectively configured to connect to the internet and to connect to the wireless computing device module (AWD_M1); the wireless computing device (AWD1) including an end-user interface, the server device (AS1, ASn) including no direct end-user interface, the method including the steps of:
(i) one of the ATM transceivers downloading a software module (AFMPD_M1) and a wireless device interface module (AFMPD_INT1); the ATM device (AFMPD1) automatically upon download of the software module (AFMPD_M1) making the software module (AFMPD_M1) via the wireless device interface module (AFMPD_INT1) operable to communicate with the wireless computing device module (AWD_M1) through the wireless computing device interface (AWD_INT1);
ii), at least two built-in transceivers of the wireless computing device connecting to the internet and connecting to the ATM device (AFMPD1), wherein one of the wireless computing device transceivers downloads a respective software module (AWD_M1) and a wireless computing device interface module (AWD_INT1); wherein the wireless computing device (AWD1) automatically upon download of the software module (AWD_M1) makes the software module (AWD_M1) through the wireless computing device interface module (AWD_INT1) operable to communicate with the ATM software module (AFMPD_M1) through the wireless device interface (AFMPD_INT1);
iii) the server device downloading or embedding a respective software module (AS1_M, ASn_M); wherein the server device (AS1, ASn) automatically upon download or embedding of the software module (AS1_M, ASn_M) makes the software module (AS1_M, ASn_M) operable to communicate with the ATM software module (AFMPD_M1) and with the wireless computing device module (AWD_M1), through the internet (100);
iv) the ATM device (AFMPD1) including the downloaded software module (AFMPD_M1) scanning through one, some or all of its available local transceivers for a communication from the wireless computing device (AWD1), wherein the wireless computing device (AWD1) with a downloaded software module (AWD_M1) directly connects to the Internet, wherein the transceivers of the ATM device (AFMPD1) are used only in receive mode, until the wireless computing device (AWD1) with a downloaded software module (AWD_M1) requests a communication with the ATM software module (AFMPD_M1), and then automatically in response a bidirectional Send/Receive mode of the ATM device (AFMPD1) and the wireless computing device (AWD1) is turned on; and
v) wherein the wireless computing device software module (AWD_M1), in response to receiving input from an end-user through the wireless computing device user interface, automatically requests a unique transaction identifier (UTID) from the server software module (AS1_M) for a transaction with a validity timeout for that UTID, sends user inputted data corresponding with that unique transaction identifier, including a transaction type, a transaction amount and a transaction currency, to the server software module (AS1_M), and the wireless computing device software module (AWD_M1) detects a communication from the ATM device software module (AFMPD_M1), in response to which the wireless computing device software module (AWD_M1) automatically sends to the ATM device software module (AFMPD_M1) a message including at least the unique transaction identifier of that transaction, the transaction type (e.g. cash deposit, cash withdrawal, other), the transaction amount, the transaction currency, and optionally a time stamp; and
vi) the ATM device (AFMPD1) determines if the wireless computing device (AWD1) is an authorized wireless computing device (AWD1) with a downloaded software module (AWD_M1), and if the ATM device (AFMPD1) determines the wireless computing device (AWD1) is an authorized wireless computing device (AWD1) with a downloaded software module (AWD_M1), then the ATM device software module (AFMPD_M1) of the ATM device (AFMPD1) auto decrypts and extracts from a communication message with the wireless computing device (AWD1) the unique transaction identifier (UTID), the transaction type, the transaction amount and the transaction currency, and
vii) wherein automatically upon receipt of a UTID from the wireless computing device software module (AWD_M1), the ATM device software module (AFMPD1) requests to the server software module (AS1_M) if the UTID is a valid UTID, wherein in the event of an expired UTID then the transaction is cancelled and, in the event the UTID is valid then the ATM device software module (AFMPD_M1) sends the extracted information to the server software module (AS1_M), including at least the unique transaction identifier (UTID), the transaction type, the transaction amount and the transaction currency, and optionally a time stamp and
viii) wherein upon the server device module (AS1_M) receiving the last of the two separate asynchronous confirmation communications from the wireless computing device software module (AWD_M1) and the ATM device software module (AFMPD_M1), corresponding to the exact same UTID, with the same transaction type, the same transaction amount and the same transaction currency, and optionally the time stamps, then the ATM device software module (AFMPD_M1) is authorized by the server device module to automatically execute the transaction, and
ix) wherein the server (AS1) software module (AFMPD_M1) notifies both the ATM device software module (AFMPD1_M1) and the wireless computing device (AWD1) software module (AWD_M1) of the transaction type and amount and currency having been executed, and
x) wherein the ATM device (AFMPD1) then executes the corresponding transaction type, wherein in the event of a cash deposit the ATM device (AFMPD1) then stores that cash in the ATM device (AFMPD1), and wherein in the event of a cash withdrawal the ATM device (AFMPD1) then dispenses that cash amount in a cash dispenser of the ATM device (AFMPD1) for the end-user of the wireless computing device (AWD1) to collect.

23. (canceled)

24. A computer-implemented method of executing a fraud-resistant transaction type, the method using a payments system, comprising: a wireless computing device (AWD1); an automated teller computing machine device (AFMPD1) and a system server (AS1), the automated teller computing machine device including a respective wireless device interface module (AFMPD_INT1), the automated teller computing machine device including an end-user interface, wherein the wireless computing device (AWD1), the automated teller computing machine device (AFMPD1) and the server device (AS1) are all internet enabled devices, and the wireless computing device (AWD1) includes a wireless computing device module (AWD_M1) and a wireless computing device interface (AWD_INT1); wherein the ATM device (AFMPD1) includes at least two built-in transceivers, respectively configured to connect to the internet and to connect to the wireless computing device module (AWD_M1), the wireless computing device (AWD1) including an end-user interface, and including at least two built-in transceivers respectively configured to connect to the internet and to connect to the ATM device (AFMPD1), the server device (AS1, ASn) including no direct end-user interface, the method including the steps of:
(i) one of the ATM transceivers downloading a software module (AFMPD_M1) and a wireless device interface module (AFMPD_INT1); automatically upon download of the software module (AFMPD_M1) making the software module (AFMPD_M1) via the wireless device interface module (AFMPD_INT1) operable to communicate with the wireless computing device module (AWD_M1) through the wireless computing device interface (AWD_INT1);
ii) one of the wireless computing device transceivers downloading a respective software module (AWD_M1) and a wireless computing device interface module (AWD_INT1); the wireless computing device (AWD1) automatically making the software module (AWD_M1) through the wireless computing device interface module (AWD_INT1) operable to communicate with the ATM software module (AFMPD_M1) through the wireless device interface (AFMPD_INT1);
iii), the server device downloading or embedding a respective software module (AS1_M, ASn_M); the server device (AS1, ASn) automatically making the software module (AS1_M, ASn_M) operable to communicate with the ATM software module (AFMPD_M1) and with the wireless computing device module (AWD_M1), through the internet (100);
iv) the ATM device (AFMPD1) including the downloaded software module (AFMPD_M1) scanning through one, some or all of its available local transceivers for a communication from the wireless computing device (AWD1), the wireless computing device (AWD1) with a downloaded software module (AWD_M1) directly connecting to the Internet, wherein the transceivers of the ATM device (AFMPD1) are used only in receive mode, until the wireless computing device (AWD1) with a downloaded software module (AWD_M1) requests a communication with the ATM software module (AFMPD_M1), and then automatically in response a bidirectional Send/Receive mode of the ATM device (AFMPD1) and the wireless computing device (AWD1) is turned on; and
v) the wireless computing device software module (AWD_M1), in response to receiving input from an end-user through the wireless computing device user interface, automatically requests a unique transaction identifier (UTID) from the server software module (AS1_M) for a transaction with a validity timeout for that UTID, sends user inputted data corresponding with that unique transaction identifier, including a transaction type, a transaction amount and a transaction currency, to the server software module (AS1_M), and the wireless computing device software module (AWD_M1) detects a communication from the ATM device software module (AFMPD_M1), in response to which the wireless computing device software module (AWD_M1) automatically sends to the ATM device software module (AFMPD_M1) a message including at least the unique transaction identifier of that transaction, the transaction type (e.g. cash deposit, cash withdrawal, other), the transaction amount, the transaction currency, and optionally a time stamp; and
vi) the ATM device (AFMPD1) determines if the wireless computing device (AWD1) is an authorized wireless computing device (AWD1) with a downloaded software module (AWD_M1), and if the ATM device (AFMPD1) determines the wireless computing device (AWD1) is an authorized wireless computing device (AWD1) with a downloaded software module (AWD_M1), then the ATM device software module (AFMPD_M1) of the ATM device (AFMPD1) auto decrypts and extracts from a communication message with the wireless computing device (AWD1) the unique transaction identifier (UTID), the transaction type, the transaction amount and the transaction currency, and
vii) automatically upon receipt of a UTID from the wireless computing device software module (AWD_M1), the ATM device software module (AFMPD1) requests to the server software module (AS1_M) if the UTID is a valid UTID, wherein in the event of an expired UTID then the transaction is cancelled and, in the event the UTID is valid then the ATM device software module (AFMPD_M1) sends the extracted information to the server software module (AS1_M), including at least the unique transaction identifier (UTID), the transaction type, the transaction amount and the transaction currency, and optionally a time stamp and
viii) upon the server device module (AS1_M) receiving the last of the two separate asynchronous confirmation communications from the wireless computing device software module (AWD_M1) and the ATM device software module (AFMPD_M1), corresponding to the exact same UTID, with the same transaction type, the same transaction amount and the same transaction currency, and optionally the time stamps, then the ATM device software module (AFMPD_M1) is authorized to automatically execute the transaction, and
ix) the server (AS1) software module (AFMPD_M1) notifying both the ATM device software module (AFMPD1_M1) and the wireless computing device (AWD1) software module (AWD_M1) of the transaction type and amount and currency having been executed, and
x) the ATM device (AFMPD1) then executes the corresponding transaction type, wherein in the event of a cash deposit the ATM device (AFMPD1) then stores that cash in the ATM device (AFMPD1), and wherein in the event of a cash withdrawal the ATM device (AFMPD1) then dispenses that cash amount in a cash dispenser of the ATM device (AFMPD1) for the end-user of the wireless computing device (AWD1) to collect.

25-32. (canceled)
